(19) United States
(12) Patent Application Publication
(10) Pub. No.: US 2015/0066916 A1
(43) Pub. Date: Mar. 5, 2015

(54) METHODS AND SYSTEMS OF AGGREGATING INFORMATION OF GEOGRAPHICAL RELATION NETWORKS BASED ON GEOGRAPHICAL LOCATIONS OF SOCIAL NETWORK COMMUNICATIONS VIA A NETWORK

(71) Applicant: Snap Trends, Inc., Austin, TX (US)

(72) Inventors: Brandon C. Burris, Austin, TX (US); Sean Harvell, Bastrop, TX (US)

(73) Assignee: Snap Trends, Inc., Austin, TX (US)

(21) Appl. No.: 14/011,531

(22) Filed: Aug. 27, 2013

(51) Int. Cl. G06F 17/30

(52) U.S. Cl. CPC G06F 17/30864; G06F 17/30241
USPC 707/723

(57) ABSTRACT

One or more systems, devices, methods, and/or processes described can determine a relation network via analyzing communications of social network users. In one example, a first group of users can be determined via a geographical search region (GSR), and a relation network can be determined via analyzing communications of the first group of users. In another example, the relation network can be determined via analyzing communications of the first group of users with a second group of users that were not directly determined via the GSR. For instance, locations of the second group of users can be determined to be associated with the GSR. For example, associating the second group of users with the GSR can include rating the second group of users, according to one or more criterions and corresponding connection strengths, and determining that the second group of users are connected to the first group of users.

### BACKGROUND

1. Technical Field

This disclosure relates generally to the field of social media data analytics. More specifically, this disclosure relates to the field of analyzing data of one or more social networks with references to geographical locations and determining social networks via analyzing the data of the one or more social networks.

2. Description of the Related Art

Social networks receive data from their users and provide a social structure of sets of individuals, groups, and/or organizations with multiple dyadic associations and/or ties between or among the sets of individuals, groups, and/or organizations. For example, a social network can receive data provided by a user and share the received data with other users affiliated with the user and/or affiliated with other users affiliated with one or more groups and/or organizations. In one instance, the data provided by the user may include a status (e.g., a personal status), a picture, a motion picture (e.g., a video), a rating of a venue, a review of a venue, or an action or activity of the user. In another instance, the data provided by the user may include a message for one or more other users affiliated with and/or related to the user. Massive amounts of useful data have been accumulated on social networks but have not been strongly leveraged for use in security, marketing, or other applications. In particular, the related art has not used geospatial references, location-based context, or a map-based interface in ascertaining the meanings and relevance of this useful data or assisting in drawing conclusions based on the geographical aspects of this data. Moreover, the related art has not used communications between or among users in determining locations of the users' computing devices and/or determining social networks of the user based on their communications.

### BRIEF DESCRIPTION OF THE DRAWINGS

The embodiments will become apparent upon reading the following detailed description and upon reference to the accompanying drawings as follows:

FIG. 1 provides a block diagram of one or more communications systems, according to one or more embodiments;

FIG. 2 provides a block diagram of a social media query system, according to one or more embodiments;

FIG. 3 provides a method of selecting a geographic area, according to one or more embodiments;

FIGS. 4-8 illustrate search regions of a map, according to one or more embodiments;

FIG. 9 provides an exemplary method of supporting a custom search region shape, according to one or more embodiments;

FIG. 10 illustrates edges of a custom search region shape covered by shapes of search regions supported by a social media data source, according to one or more embodiments;

FIG. 11 illustrates an interior of the custom search region shape covered by shapes of search regions supported by a social media data source;

FIG. 12 provides an exemplary block diagram of a computer system, according to one or more embodiments;

FIG. 13 illustrates a mobile computer system, according to one or more embodiments;

FIG. 14 illustrates an exemplary diagram of a search region that includes one or more computing devices, according to one or more embodiments;

FIG. 15 illustrates an exemplary diagram of a search region that includes multiple computing devices and communications directions between and/or among the computing devices, according to one or more embodiments;

FIG. 16 illustrates an exemplary diagram of a first determined relation network that includes one or more computing devices, according to one or more embodiments;

FIG. 17 illustrates an exemplary diagram of a second determined relation network that includes one or more computing devices, according to one or more embodiments;

FIG. 18 illustrates an exemplary diagram of a third determined relation network that includes one or more computing devices, according to one or more embodiments;

FIGS. 19A and 19B provide an exemplary method of determining a relation network via elimination of one or more results, according to one or more embodiments;

FIGS. 20A and 20B provide an exemplary method of determining a relation network via ranking of one or more results, according to one or more embodiments;

FIG. 21 illustrates a block diagram of a system that determines a rank of a result based on one or more criterions and corresponding one or more connection strengths, according to one or more embodiments; and

FIGS. 22A-22C provide an exemplary method of determining a relation network via a first one or more criterions and a second one or more criterions, according to one or more embodiments.

While one or more embodiments may be susceptible to various modifications and alternative forms, specific embodiments thereof are shown by way of example in the drawings and will herein be described in detail. It should be understood, however, that the drawings and detailed description thereto are not intended to limit the disclosure to the particular form disclosed, but on the contrary, the disclosure is to cover all modifications, equivalents and alternatives falling within the spirit and scope of this disclosure.

### DETAILED DESCRIPTION

In one or more embodiments, systems, methods, and/or processes described herein can provide one or more interfaces that can search and/or filter data of social networks (e.g., Facebook, Twitter, YouTube, Weibo, a blog, a wiki, Foursquare, Instagram, Flickr, Vimeo, Yelp, etc.) with respect to one or more of a geospatial references, location-based contexts, and/or map-based references. For example, user input can be received that can move a searchable eye of variable dimension about a map interface to denote a search region, and data associated with one or more social networks can be searched and/or filtered with respect to the denoted search region. For instance, one or more social networks can be queried with one or more search and/or filter parameters and one or more geographic locations associated with the denoted search region, and one or more results can be received from the one or more social networks, where the results can be based on the one or more search and/or filter parameters and one or more geographic locations associated with the denoted search region.

In one or more embodiments, subject-related groups can be defined and/or categorized by one or more of discussion and affinity criteria, among others. For example, one or more of time/subject phases of dominance by individuals, individual participant relationship to one or more groups, and individuals to their respective network of contacts, among others, can be mapped.

In one or more embodiments, queries can be saved with their geospatial references and their search and/or filter parameters. For example, one or more saved queries can continue to run and/or execute over one or more periods of time transpiring. In one or more embodiments, queries can be saved with their geospatial references and their search and/or filter parameters. For example, one or more saved queries can continue to run and/or execute over one or more periods of time transpiring. In one or more embodiments, methods, processes, and/or systems can query a social network with one or more search and/or filter parameters and one or more geographic locations associated with a denoted search region. For example, the social network can be queried via an application programming interface (API). For instance, the social network can provide the API. In one or more embodiments, the social network can be queried via a network (e.g., a public network, a private network, etc.), and one or more results of the query can be received via the network. In one example, the API can include a hypertext transfer protocol (HTTP) interface, and the social network can be queried via the HTTP interface. In a second example, the API can include a hypertext transfer protocol secure (HTTPS) interface, and the social network can be queried via the HTTPS interface. In another example, the API can be utilized with one or more secure communication methods, processes, and/or systems. For instance, the API can be utilized with and/or via one or more of a virtual private network, a secure tunnel, a secure socket layer (SSL), and a transport layer security (TLS) protocol, among others.

In one or more embodiments, the one or more results of the query of the social network can be provided to a user as the one or more results become available from the social network. For example, the one or more results can be provided to a user via a user interface (e.g., a graphical user interface) as the one or more results become available from the social network.

In one or more embodiments, the one or more results of a query of the social network can be received over one or more periods of time transpiring. For example, one or more queries can be provided to a social media network data source (e.g., a data source that can store social media network data), the one or more queries can be saved (e.g., stored) with their geospatial references and their search and/or filter parameters, an amount of time can transpire, the one or more queries can be retrieved (e.g., retrieved from storage), the one or more queries can be provided (again, in a repeated fashion, etc.) to the social media network data source, and one or more search results can be received from the social media network data source. For instance, running and/or executing one or more saved queries can provide continual and/or periodic reporting.

In one or more embodiments, one or more methods, processes, and/or systems, described herein, can utilize one or more event-driven one social network media data source methods, processes, and/or systems. In one example, one or more events can be generated (e.g., a data ready event, a timer event, a timeout event, a periodic timer event, a processing system ready event, a data send event, etc.), and one or more event handlers can perform one or more methods and/or processes in response to the one or more events. In one instance, the one or more event handlers can receive and/or process data associated with the one or more events. In a second instance, the one or more event handlers can provide data in response to the one or more events. In another instance, the one or more event handlers can generate one or more additional events in response to the one or more events.

In one example, a data ready event can be generated when data has been received from a social media network data source, and a data ready event handler can process the data received from the social media network data source. In a second example, a timeout event can be generated, and a timeout event handler can retrieve (e.g., retrieve from storage) one or more queries saved queries and can provide the one or more queries saved queries to a social media network data source. In one instance, a timer can be set with an amount of time to transpire, and the timeout event can be generated in response to the amount of time transpiring. In another instance, a timer can be set with a time (e.g., 10:30, 16:45 on 11 Dec. 2012, 23:02 on 26 July, etc.), and the timeout event can be generated in response to the time occurring.

In another example, a periodic timeout event can be generated, and a periodic timeout event handler can retrieve (e.g., retrieve from storage) one or more queries saved queries and can provide the one or more queries saved queries to a social media network data source. In one instance, a periodic timer can be set with an amount of time to transpire, and the periodic timeout event can be generated in response to the amount of time transpiring. In one or more embodiments, the periodic timeout event can be generated, repeatedly, in response to each repetition of the amount of time transpiring. For, one or more methods, processes, and/or systems, described herein, can query a social media data source at a time interval.

In one or more embodiments, one or more methods, processes, and/or systems, described herein, can query the social network in a continuous fashion. For example, the social network can be queried until one or more results are received or until an amount of time has transpired. For instance, one or more methods, processes, and/or systems, described herein, can query the social network in a background process and/or in an automated batch. For example, one or more saved queries can continue to run and/or execute over one or more periods of time transpiring. For instance, running and/or executing one or more saved queries can provide continual and/or periodic reporting.

In one or more embodiments, methods, processes, and/or systems, described herein, can provide and/or implement one or more user interfaces. For example, the one or more user interfaces can provide one or more of social network query results, statistical analyses of data from the social network query results, one or more charts (e.g., a chart illustrating a number of results returned vs. each time the query was performed), a review of results determined and content that was saved, and/or some or all of the social network query results layered over a map, among others. In one or more embodiments, one or more of social network query results and statistical analyses of data from the social network query results, among others, can be utilized in training a neural network. For example, trainable data sets can be utilized for pattern initial guidance. For instance, one or more methods and/or processes can be trained from data sets and can automatically acquire an artificial intelligence to increase one or more of group, individual, and intent mapping aptitude over a period of time.

In one or more embodiments, one or more relation networks can be determined. For example, determining a relation network can include determining communications between or among users. In one instance, determining a relation network can include determining communications between or among users of Facebook. In another instance, determining a relation network can include determining communications between or among users of Twitter. In one or more embodiments, single direction communications and/or multiple direction communications can be utilized in determining one or more relation networks. For example, a group of users of a first social network (e.g., Facebook, Twitter, etc.) can be determined via a search region, and a second social network (e.g., a network of users within the first social network) can be determined via eliminating one or more users that do not bidirectionally communicate with at least one other user of the group of users of the first social network.

In one or more embodiments, one or more criterion can be utilized to rank and/or rate one or more users to determine a social network. For example, a group of users of a first social network (e.g., Facebook, Twitter, etc.) can be determined via a search region, and one or more criterion can be utilized to rank the group of users to determine a social network. For instance, one or more users that are not ranked and/or rated high enough can be eliminated and/or ignored to produce and/or generate a second social network (e.g., a network of users within the first social network).

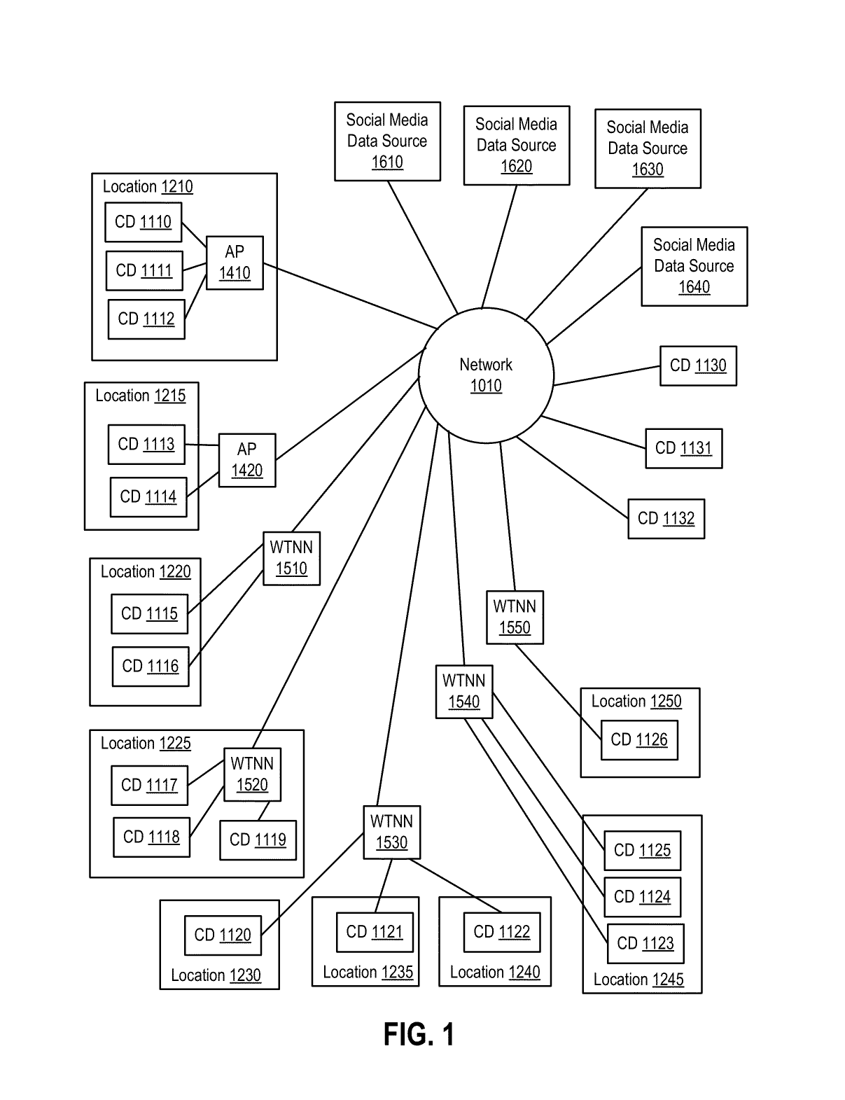

Turning now to FIG. 1, one or more network systems are illustrated, according to one or more embodiments. As shown, one or more social media data sources 1610-1640 can be coupled to a network 1010. In one or more embodiments, a social media data source (which can also be referred to as a social network media data source) can include a social media service and/or one or more computer systems that are operated and/or controlled by the social media service. For example, the social media service can provide and/or include one or more web-based interfaces (e.g., one or more websites and/or one or more network-based application programming interfaces) and/or mobile-based technologies and/or services that can facilitate and/or implement communications and/or interactive dialogues among related individuals, organizations, and/or communities, among others. For instance, the social media service can provide and/or implement Internet-based applications (e.g., websites, network-based programming interfaces, etc.) that can facilitate and/or provide a creation and/or an exchange of user input (e.g., user-generated data, user-provided content, etc.). In one example, social media data sources 1610-1640 can include Facebook, Twitter, YouTube, and Weibo. In another example, the social media data sources can include MySpace, Friendster, a blog, a wiki, Foursquare, Instagram, Flickr, Vimeo, and Yelp, among others.

In one or more embodiments, one or more of social media data sources 1610-1640 can provide application programming interfaces that provide functionalities that can receive one or more queries and can provide social media data corresponding to and/or associated with the one or more queries. For example, social media data source 1610 can receive a query associated with one or more of a word, a phrase, a user profile, a portion of a user profile, a regular expression, a natural language filter, a grammar (e.g., a set of formation rules for strings in a language, a context-free grammar, a regular grammar, a tree-adjoining grammar, an affix grammar, an attribute grammar, an adaptive grammar, an ambiguous grammar, a categorical grammar, etc.), a social group, an organization, a user identification, and/or a location, among others, and can provide social media data that is associated with and/or corresponds to at least one of the word, the phrase, the grammar, the regular expression, the user profile, the portion of the user profile, the social group, the organization, the user identification, and the location. For instance, social media data source 1610 can receive a query associated with one or more locations and provide the location-based social media data matching that query via network 1010. In one or more embodiments, a user profile can include one or more of a user name, a user identification, a mobile telephone number, an email address, a physical address, an occupation, a gender, a marital status, a past purchase, an interest, a past transaction, a shoe size, an age, one or more clothing sizes, a political affiliation, a monthly include, a yearly income, an employment status, a credit history, a credit rating, an eye color, a hair color, a music genre, and a membership, among others.

As illustrated, computing devices (CDs) 1110-1112 and an access point (AP) 1410 can be at and/or associated with a location 1210, and CDs 1110-1112 can be coupled to AP 1410 that can be coupled to network 1010. In one or more embodiments, AP 1410 can communicate with one or more computing devices in one or more of a wired fashion and a wireless fashion. In one example, AP 1410 can communicate with one or more of CDs 1110-1112 in a wired fashion. For instance, AP 1410 can communicate with CDs 1110-1112 via one or more of wired Ethernet, fiber optics, wired universal serial bus (USB), digital subscriber loop (DSL), and coaxial cable (e.g., cable TV), among others.

In another example, AP 1410 can communicate with one or more of CDs 1110-1112 in a wireless fashion. For instance, AP 1410 can communicate with CDs 1110-1112 via one or more of wireless Ethernet (e.g., WiFi), Institute of Electrical and Electronics Engineers (IEEE) 802.11, IEEE 802.16, WiMAX, Bluetooth, IEEE 802.15, ZigBee, Z-Wave, ultra wideband, IEEE 802.15.4, and wireless USB, among others. In one or more embodiments, an AP can include a transceiver to communicate with computing devices utilizing one or more wireless methods, processes, wireless spectrums (e.g., frequency ranges), protocols, and/or systems. For example, an AP can communicate with computing devices utilizing ISM (industrial, scientific and medical) bands. For instance, an ISM band can include a frequency range of 6.765-6.795 Mhz, 433.05-434.79 Mhz, 902-928 Mhz, 2.4-2.5 Ghz, 5.725-5.875 Ghz, or 24.0-24.25 Ghz, among others.

As shown, CDs 1113 and 1114 can be at and/or associated with a location 1215, CDs 1113 and 1114 can be coupled to an AP 1420 that can be coupled to network 1010. In one or more embodiments, AP 1420 can include one or more structures and/or functionalities described with reference to AP 1410. For example, AP 1420 can communicate with one or more computing devices in one or more of a wired fashion and a wireless fashion. As illustrated, AP 1420 may not be at and/or associated with a location 1215, according to one or more embodiments.

As shown, CDs 1115 and 1116 can be at and/or associated with a location 1220, and CDs 1115 and 1116 can be coupled to a wireless telephone network node (WTNN) 1510 that can be coupled to network 1010. In one example, WTNN 1510 can include one or more of a base station subsystem (BSS), a base station controller (BSC), and a base transceiver station (BTS) that can be coupled to network 1010. In a second example, WTNN 1510 can include one or more of a radio network controller (RNC) and a Node B. For instance, a Node B can include and/or denote a BTS of a universal mobile telecommunications system (UMTS) and can include one or more transmitters, one or more receivers, one or more transceivers, and/or one or more antennas. In another example, a WTNN can include a satellite that can orbit a planet (e.g., Earth) and can be wirelessly coupled to network 1010. For instance, the WTNN can orbit the planet in a low planetary orbit (e.g., a low Earth orbit), a medium planetary orbit (e.g., a medium Earth orbit), a geostationary orbit, a high planetary orbit (e.g., a high Earth orbit), a semi-synchronous orbit, or a geosynchronous orbit, among others.

In one or more embodiments, a WTNN can communicate with one or more computing devices via one or more protocols such as one or more of wideband code division multiple access (WCDMA), time division synchronous code division multiple access (TD-SCDMA), code division multiple access (CDMA), time division multiple access (TDMA), GSM (global system for mobile communications), long term evolution (LTE), general packet radio service (GPRS), enhanced GPRS (EGPRS), frequency division multiple access (FDMA), and enhanced data rates for GSM evolution (EDGE), among others. In one or more embodiments, a WTNN can include one or more transmitters, one or more receivers, one or more transceivers, one or more antennas, and/or one or more cryptography devices that can be used to wirelessly communicate with one or more computing devices. In one example, the one or more antennas of the WTNN can be mounted on a mast, on a tower (e.g., a cellular telephone communications tower), on a side of a structure (e.g., a building, a parking garage, a lamp post, etc.), and/or on a roof of a building, among others.

As illustrated, CD 1117-1119 and a WTNN 1520 can be at and/or associated with a location 1225, and CDs 1117-1119 can be coupled to WTNN 1520 that can be coupled to network 1010. In one or more embodiments, WTNN 1520 can include one or more structures and/or functionalities described with reference to WTNN 1510. As shown, CDs 1120-1122 can be at and/or associated with respective locations 1230-1240, and CDs 1120-1122 can be coupled to a WTNN 1530 that can be coupled to network 1010. In one or more embodiments, WTNN 1530 can include one or more structures and/or functionalities described with reference to WTNN 1510. As shown, WTNN 1530 may not be at and/or associated with one or more of locations 1230-1240, according to one or more embodiments.

As illustrated, CD 1123-1125 can be at and/or associated with a location 1245, and CDs 1123-1125 can be coupled to WTNN 1540 that can be coupled to network 1010. In one or more embodiments, WTNN 1540 can include one or more structures and/or functionalities described with reference to WTNN 1510. As shown, WTNN 1540 may not be at and/or associated with location 1245, according to one or more embodiments. As illustrated, a computing device (CD) 1126 can be at and/or associated with a location 1250, and CD 1126 can be coupled to a WTNN 1550 that can be coupled to network 1010. In one or more embodiments, WTNN 1550 can include one or more structures and/or functionalities described with reference to WTNN 1510. As shown, WTNN 1550 may not be at and/or associated with location 1250, according to one or more embodiments. As illustrated, one or more CDs 1130-1132 can be coupled to network 1010.

In one or more embodiments, network 1010 and/or network 1014 can include a wired network, a wireless network or a combination of wired and wireless networks. Network 1010 and/or network 1014 can include and/or be coupled to various types of communications networks, such as a public switched telephone network (PSTN), an Internet, a wide area network (WAN) (e.g., a private WAN, a corporate WAN, a public WAN, etc.), a local area network (LAN), etc. In one or more embodiments, NMD 1020 can be coupled to a PSTN, e.g., Ethernet cable and DSL; a cable (television) based network; a satellite-based system; and/or a fiber based network; among others. In one or more embodiments, network 1010 can include one or more wireless networks, e.g., based on IEEE 802.11 and/or IEEE 802.16.

In one or more embodiments, network 1010 can be or include a communications network. In one example, network 1010 can be or include multiple networks and/or can be coupled to one or more other networks. For instance, network 1010 can be, include, or form part of a WAN. For instance, the WAN can include one or more of a private WAN, a corporate WAN, and a public WAN (e.g., an Internet), among others. In another example, network 1010 can be or include a telephone network. In one instance, network 1010 can be or include a PSTN. In a second instance, network 1010 can be or include a wired telephone network. In another instance, network 1010 can be or include a wireless telephone network (e.g., a cellular telephone network, a satellite telephone network, etc.).

In one or more embodiments, network 1010 can include and/or be coupled to various types of communications networks. For example, network 1010 can include and/or be coupled to a PSTN, an Internet, a WAN (e.g., a private WAN, a corporate WAN, a public WAN, etc.), and/or a LAN, among others. In one or more embodiments, network 1010 can include a wired network, a wireless network or a combination of wired and wireless networks. In one example, network 1010 can include and/or be coupled to coupled to a wired PSTN, a DSL network, a cable (television) based network, a satellite-based system and/or network, and/or a fiber based network; among others. In another example, network 1010 can include and/or be coupled to one or more wireless networks, e.g., based on IEEE 802.11, based on IEEE 802.16, based on a wireless PSTN, based on a wireless telecommunications network, etc.

In one or more embodiments, a network system can be or include a communication system. For example, a network system can be operated by a network provider. For instance, a first network system can be operated by a first network provider (e.g., AT&T, T-Mobile, Iridium Communications, Verizon Wireless, Globalstar, etc.), and a second network system can be operated by a second network provider (e.g., Time-Warner Cable, Wayport, Boingo, Qwest, CLEAR, Grande Communications, Cox, EarthLink, etc.).

In one or more embodiments, one or more of CDs 1110-1126 can be or include any of various types of devices, including a computer system, such as a desktop computer system, a portable computer, a laptop computer system, a personal digital assistant (PDA), a smart phone, a wireless telephone (e.g., a cellular telephone, a satellite telephone, etc.), a digital music player, a tablet computing device, a wearable computing device, a communications device, or other wired or wireless device. In one example, a first user can utilize CD 1110 at location 1210. For instance, CD 1110 can be or include a laptop computing device. In a second example, a second user can utilize CD 1111 at location 1210. For instance, CD 1111 can be or include a tablet computing device. In a third example, a third user can utilize CD 1113 at location 1215. For instance, CD 1113 can be or include a personal digital assistant. In another example, a fourth user can utilize CD 1115 at location 1220. For instance, CD 1115 can be or include a wireless telephone.

In one or more embodiments, respective users of CDs 1110, 1111, 1113, and 1115, at and/or associated with respective locations, can provide data to one or more social media services, where the user-provided data can be associated with and/or correspond to the respective locations. In one example, the first user can utilize CD 1110 to update a status (e.g., a personal status) on a first social media service (e.g., associated with social media data source 1610) such that the updated status corresponds to a location of CD 1110. For instance, the updated status and information associated with location 1210 can be stored by first social media service such that the updated status is associated with location data such that the updated status corresponds to location 1210. In a second example, the second user can utilize CD 1111 to upload a picture and/or a motion picture (e.g., a video) to a second social media service (e.g., associated with social media data source 1620). For instance, the picture and/or the motion picture and information associated with location 1210 can be stored by second social media service such that the picture and/or the motion picture corresponds to location 1210. In a third example, the third user can utilize CD 1113 to rate and/or review a venue (e.g., a restaurant, a coffee shop, a movie theatre, a car wash, etc.) on a third social media service (e.g., associated with social media data source 1630). For instance, the rating and/or the review and information associated with location 1215 can be stored by third social media service such that the rating and/or the review correspond to location 1215.

In another example, the fourth user can utilize CD 1115 to update an action and/or activity on a fourth social media service (e.g., associated with social media data source 1640). In one instance, the action and/or the activity and information associated with location 1220 can be stored by the fourth social media service such that the action and/or the activity corresponds to location 1220. In another instance, the action and/or the activity can be related to the fourth user (e.g., entering a football stadium) or can be related to actions and/or activities of others in the vicinity of location 1220 (e.g., gunshot(s) fired, car crash, a parade, etc.). In yet another instance, the action and/or the activity can be related to the environment in the vicinity of location 1220 (e.g., building fire, brush fire, gas leak, explosion, lightening storm, earthquake, etc.).

In one or more embodiments, a location (e.g., a location of locations 1210-1250), associated with and/or corresponding to a computing device, can be determined. For example, a location, described herein, can be or include a geographical location. For instance, a location (e.g., a location of locations 1210-1250) can include one or more of a street number, a street, a zip code, a city, a state, a country, a unit identifier (e.g., a suite identifier, a condominium identifier, a hospital room identifier, an apartment identifier, a gate identifier of an airport, an airport identifier, etc.), a cell identification (cell ID or CID associated with a cellular telephone network), latitude information, longitude information, and altitude information, among others. In one or more embodiments, a location can be, include, or be associated with one or more of a voting district, a congressional district, a school district, a school, a campus, a dormitory, an oil pipeline, a sports complex, a police precinct, a piece of real estate, a neighborhood, a borrow, a city, a town, a commercial office building, a floor of a building, a factory, a refinery, a storage facility, a power station, a power substation, and a military installation, among others.

In one or more embodiments, a location (e.g., a location of locations 1210-1250) can be determined based on a location of an AP communicating with a computing device. For example, one or more of CDs 1110-1112 can communicate with AP 1410, which is associated with and/or corresponding to location 1210, and can be determined to be at and/or associated with location 1210. In one or more embodiments, a location (e.g., a location of locations 1210-1250) can be determined based on a location of a WTNN communicating with a computing device. For example, one or more of CDs 1117-1119 can communicate with WTNN 1520, which is associated with and/or corresponding to location 1225, and can be determined to be at and/or associated with location 1225.

In one or more embodiments, a location (e.g., a location of locations 1210-1250) can be determined based on locations of multiple wireless telephone network nodes (WTNNs) communicating or being capable of communicating with a computing device. For example, CD 1122 can communicate or can be capable of communicating with two or more of WTNNs 1530-1550, and a location of CD 1122 (e.g., location 1240) can be determined based on two or more of WTNNs 1530-1550 and their locations. In one instance, a location of a computing device can be determined via multilateration which is a navigation technique that utilizes measurements of differences in distances to two or more WTNNs, at previously determined or known locations, that broadcast one or more signals at previously determined or known times. In a second instance, a location of a computing device can be determined via trilateration which is a navigation technique that utilizes distances or absolute measurements of time-of-flight from three or more WTNNs. In another, a location of a computing device can be determined via triangulation which is a navigation technique that utilizes measurements of absolute angles. In one or more embodiments, a computing device and/or a network operator can utilized multiple WTNNs in determining a location of the computing device.

In one or more embodiments, a location of a computing device is determined utilizing data from a positioning device and/or mechanism. For example, the computing device can include a global positioning system (GPS) device and/or mechanism, and the computing device can communicate its location information, from the GPS device and/or mechanism, to a social media data source. In one or more embodiments, a location of a computing device can be determined utilizing a network address utilized by the computing device. For example, the network address can include an Internet protocol (IP) address or other address utilized by the computing device and/or an IP address or other address of a gateway associated with the computing device. In one instance, a database can include multiple IP addresses that correspond to multiple locations, and the database can be queried with an IP address and can provide a location based on the IP address. In another instance, the network address can be or include a network address of a communication system.

In one or more embodiments, a computing device that is communicating with a social network can provide a location of the computing device to the social network. In one example, the computing device can provide latitude and longitude information, from a GPS device and/or mechanism, to the social network. In another example, the computing device can provide one or more of street number information, street information, zip code information, city information, state information, and country information, among others, to the social network.

In one or more embodiments, user-provided data (e.g., user-provided content, user input, user-provided pictures, user-provided motion pictures, user-provided videos, communications and/or interactive dialogues among related individuals, organizations, and/or communities, user status updates, posts to one or more social network services, one or more blog entries, etc.) can be correlated and/or associated with a location of a computing device, utilized by a user, that provides the user-provided data to a social media service via a network. In one example, first user input can be correlated and/or associated with a first location of a first computing device, utilized by a first user, that provides the first user input to a first social media service via network 1010. For instance, the first user input can be correlated and/or associated with location 1210 of CD 1110, utilized by the first user, that provides the first user input to a first social media service via network 1010.

In a second example, second user input can be correlated and/or associated with a second location of a second computing device, utilized by a second user, that provides the second user input to a second social media service via network 1010. For instance, the second user input can be correlated and/or associated with location 1215 of CD 1113, utilized by the second user, that provides the second user input to a second social media service via network 1010. In a third example, third user input can be correlated and/or associated with a third location of a third computing device, utilized by a third user, that provides the third user input to a third social media service via network 1010. For instance, the third user input can be correlated and/or associated with location 1245 of CD 1123, utilized by the third user, that provides the third user input to a third social media service via network 1010.

In a fourth example, fourth user input can be correlated and/or associated with the first location of a fourth computing device, utilized by a fourth user, that provides the fourth user input to a fourth social media service via network 1010. For instance, the fourth user input can be correlated and/or associated with location 1210 of CD 1111, utilized by the fourth user, that provides the fourth user input to a fourth social media service via network 1010. In a fifth example, fifth user input can be correlated and/or associated with a fifth location of a fifth computing device, utilized by a fifth user, that provides the fifth user input to the first social media service via network 1010. For instance, the fifth user input can be correlated and/or associated with location 1240 of CD 1122, utilized by the fifth user, that provides the fifth user input to a fifth social media service via network 1010. In a sixth example, sixth user input can be correlated and/or associated with the second location of a sixth computing device, utilized by a sixth user, that provides the sixth user input to the second social media service via network 1010. For instance, the sixth user input can be correlated and/or associated with location 1215 of CD 1114, utilized by the sixth user, that provides the sixth user input to a sixth social media service via network 1010.

In one or more embodiments, user input correlated and/or associated with a location of a computing device can be provided to a social media service via one or more of a web interface, a post (e.g., a HTTP POST), a get (e.g., a HTTP GET), a smart phone application, a tablet application, a digital music player application, a personal digital assistant application, an application for a personal computer (e.g., a desktop computer, a notebook computer, etc.), and an application for a virtual machine, among others.

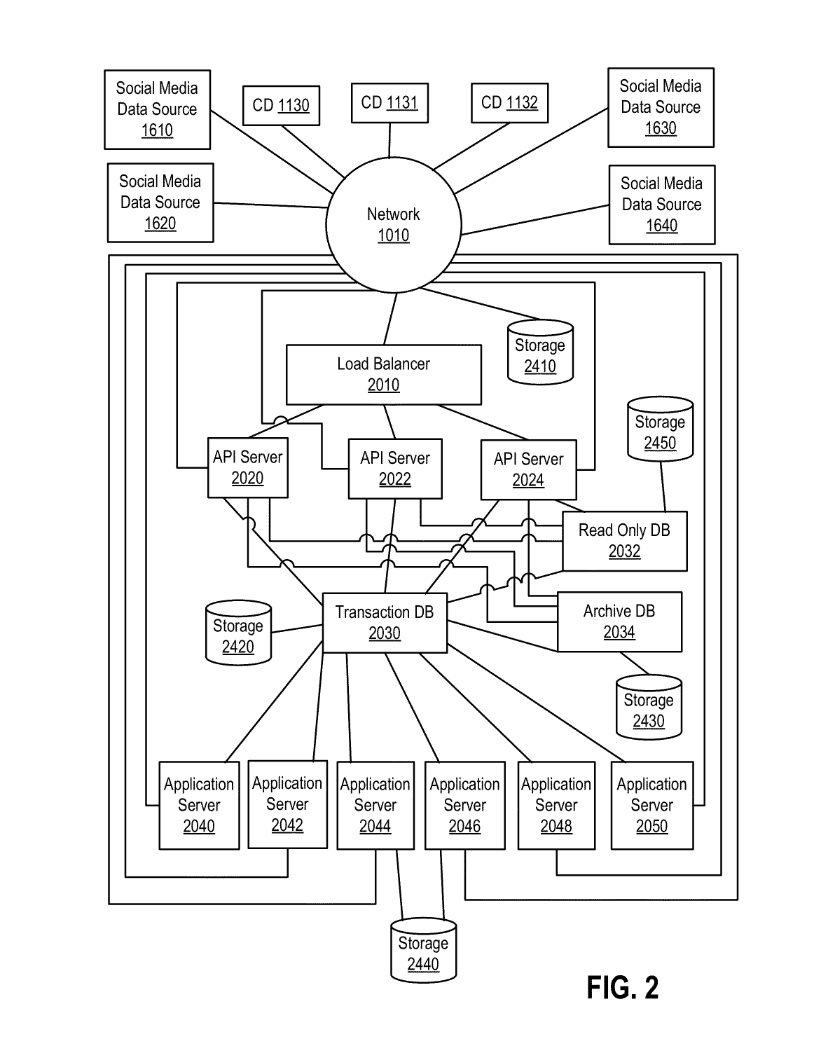

Turning now to FIG. 2, a social media query system is illustrated, according to one or more embodiments. As shown, one or more of CDs 1130-1132 and/or one or more of social media data sources 1610-1640 can be coupled to network 1010. In one or more embodiments, one or more of CDs 1130-1132 can be or include one or more clients of the social media query system. For example, one or more of CDs 1130-1132 can provide one or more queries to one or more API servers 2020-2024 via network 1010 and via a load balancer 2010. For instance, load balancer 2010 can distribute queries between or among two or more API servers in accordance with one or more load balancing methods and/or processes.

As illustrated, API servers 2020-2024 can be coupled to network 1010. In one or more embodiments, one or more API servers 2020-2024 can query one or more social media data sources 1610-1640. For example, one or more API servers 2020-2024 can receive one or more live queries from one or more of CDs 1130-1132 and can query one or more social media data sources 1610-1640, via network 1010, to provide one or more responses to the live queries. For instance, a live query can include a query for data that has not been archived.

In one or more embodiments, one or more API servers 2020-2024 can utilize one or more network monitors and/or packet analyzers (not shown) to monitor network traffic on network 1010 and capture network packets en route to one or more social media data sources 1610-1640 including information related to a query. For example, one or more API servers 2020-2024 can receive one or more queries from one or more of CDs 1130-1132 and intercept network packets destined for one or more social media data sources 1610-1640 via network 1010 to provide one or more responses to the queries based on content of the captured network packets.

In one or more embodiments, data provided to the social media services can be associated with and/or correspond to respective locations of computing devices that provided the data, and API servers 2020-2024 can query the one or more social media services to determine information associated with and/or corresponding to the data provided to the social media services and respective locations of the computing devices that provided the data. In one example, API server 2020 can provide, to social media data source 1610, a first query associated with one or more of a first word, first words, a first phrase, a first user profile, a portion of the first user profile, a first grammar, a first regular expression, a first social group, a first organization, a first user identification, and a first location, among others, and receive social media data that is associated with and/or corresponds to at least one of the first word, the first words, the first phrase, the first user profile, the portion of the first user profile, the first grammar, the first regular expression, the first social group, the first organization, the first user identification, and the first location. For instance, API server 2020 can provide the first query to social media data source 1610 via network 1010 and can receive the first social media data from social media data source 1610 via network 1010.

In a second example, API server 2022 can provide, to social media data source 1620, a second query associated with one or more of a second word, second words, a second phrase, a second user profile, a portion of the second user profile, a second grammar, a second regular expression, a second social group, a second organization, a second user identification, and a second location, among others, and receive second social media data that is associated with and/or corresponds to at least one of the second word, the second words, the second phrase, the second user profile, the portion of the second user profile, the second grammar, the second regular expression, the second social group, the second organization, the second user identification, and the second location. For instance, API server 2022 can provide the second query to social media data source 1620 via network 1010 and can receive the second social media data from social media data source 1620 via network 1010.

In another example, API server 2024 can provide, to social media data source 1630, a third query associated with one or more of a third word, third words, a third phrase, a third user profile, a third portion of the third user profile, a third grammar, a third regular expression, a third social group, a third organization, a third user identification, and a third location, among others, and receive third social media data that is associated with and/or corresponds to at least one of the third word, the third words, the third phrase, the third user profile, the portion of the third user profile, the third grammar, the third regular expression, the third social group, the third organization, the third user identification, and the third location. For instance, API server 2024 can provide the third query to social media data source 1630 via network 1010 and can receive the third social media data from social media data source 1630 via network 1010.

In one or more embodiments, social media data from a social media data source can be stored in a database (DB). For example, one or more of the first social media data from social media data source 1610, the second social media data from social media data source 1620, and the third social media data from social media data source 1630 can be stored in a transactional DB 2030. In one or more embodiments, transactional DB 2030 can provide social media data from a social media data source to one or more of a read only DB 2032 and an archive DB 2034. In one example, read only DB 2032 can be utilized for queries associated with and/or corresponding to data that has been received from a social media data source. For instance, read only DB 2032 can be utilized to off-load queries from transaction DB 2030. In a second example, archive DB 2034 can be utilized for long-term storage of queries associated with and/or corresponding to data that has been received from a social media data source. In another example, archive DB 2034 can be utilized for queries over a period of time.

In one or more embodiments, one or more of transactional DB 2030, read only DB 2032, and archive DB 2034 can include and/or be implemented via multiple computing devices and/or multiple databases. In one example, transactional DB 2030 can include at least one computer system for each API server coupled to transactional DB 2030. In another example, one or more of read only DB 2032 and archive DB 2034 can include multiple computing devices to process data in a parallel fashion. For instance, a DB can divide a data processing problem (e.g., a query), distribute portions of the data and/or portions the problem to multiple computing devices, and combine results from the multiple computing devices that were provided the portions of the data and/or the portions the problem.

In one or more embodiments, a database can include a relational database management system (RDBMS) that can be accessed by one or more computer systems. For example, the RDBMS can include an Oracle database, a Microsoft SQL Server database, a MySQL database, a PostgreSQL database, etc. In one or more embodiments, a database can include an object oriented database. For example, the object oriented database can include an Informix database, an Objectivity/DB database, a FastObjects database, a JADE database, a VelocityDB database, an ObjectDB database, etc. In one or more embodiments, a database can include a combination of a RDBMS and an object oriented database system.

As illustrated, transactional DB 2030 can be coupled to one or more of API servers 2020-2024, read only DB 2032, archive DB 2034, and application servers 2040-250. In one or more embodiments, one or more of applications servers 2040-2050 can process and/or issue one or more queries to one or more social media data sources. For example, applications servers 2040-2050 can process and/or issue one or more queries to social media data sources over a period of time. In one or more embodiments, one or more of applications servers 2040-2050 can receive, process, analyze and/or present one or more results of one or more queries to one or more social media data sources.

As shown, a storage 2410 can be coupled to network 2410. In one or more embodiments, one or more of API servers 2020-2024, databases 2030-2034, and application servers 2040-2050 can utilize storage 2420 via network 1010. As illustrated, storages 2420, 2430, and 2450 can be coupled to one or more transaction DB 2030, archive DB 2430, and read only DB 2032, respectively. In one or more embodiments, one or more of storages 2420, 2430, and 2450 can be coupled to a respective database via one or more of SATA (serial AT attachment), SAS (serial attached SCSI), and FCoE (fiber channel over Ethernet). For example, storage 2420 can be coupled to database 2030 via Ethernet. For instance, FCoE can map storage 2420 to database 2030 independent of an Ethernet forwarding scheme. In one or more embodiments, one or more of storages 2410-2450 can be, be included in, or include at least one of a network attached storage (NAS) and a storage area network (SAN), among others.

As illustrated, a storage 2440 can be coupled to one or more of applications servers 2044 and 2046. In one or more embodiments, one or more of storage 2440 can be coupled to one or more of application servers 2440 via one or more of SATA, SAS, and FCoE. For example, storage 2420 can be coupled to database 2030 via Ethernet.

In one or more embodiments, one or more of storages 2410-2450 can include one or more storage devices that can be utilized to store database data (e.g., tables, database schemes, etc.) and/or one or more queries of one or more social media data sources. For example, one or more of storages 2410-2450 can store one or more queries generated via one or more methods, processes and/or systems described herein. In one or more embodiments, one or more stored queries can be retrieved from one or more of storages 2410-2450.

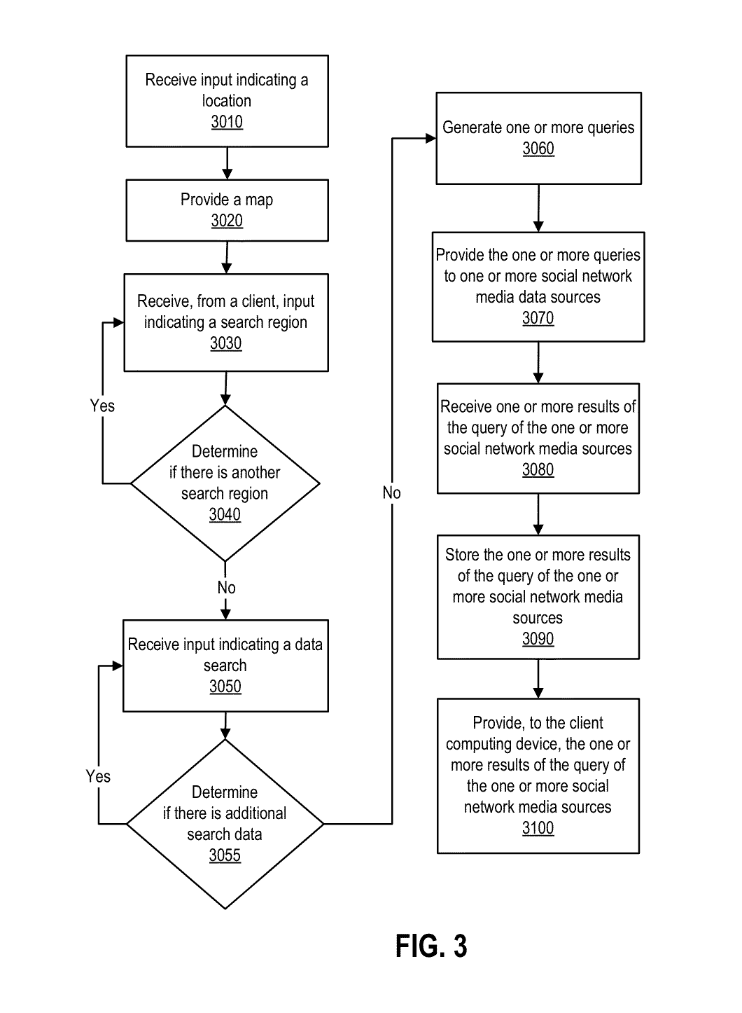

Turning now to FIG. 3, a method of selecting a geographic area is illustrated, according to one or more embodiments. At 3010, input indicating a location can be received. For example, an API server of API servers 2020-2024 can receive input indicating the location from a client (e.g., one of CDs 1130-1132) via network 1010. For instance, the location can include one or more of a coordinate (e.g., latitude, longitude, etc.), a city, a state, a zip code, and a country, among others. In one or more embodiments, the input can include at least one of user input and machine input (e.g., from a database system), among others. At 3020, a map can be provided. For example, an API server of API servers 2020-2024 can provide a map to the client. For instance, the map can include the location received at 3010.

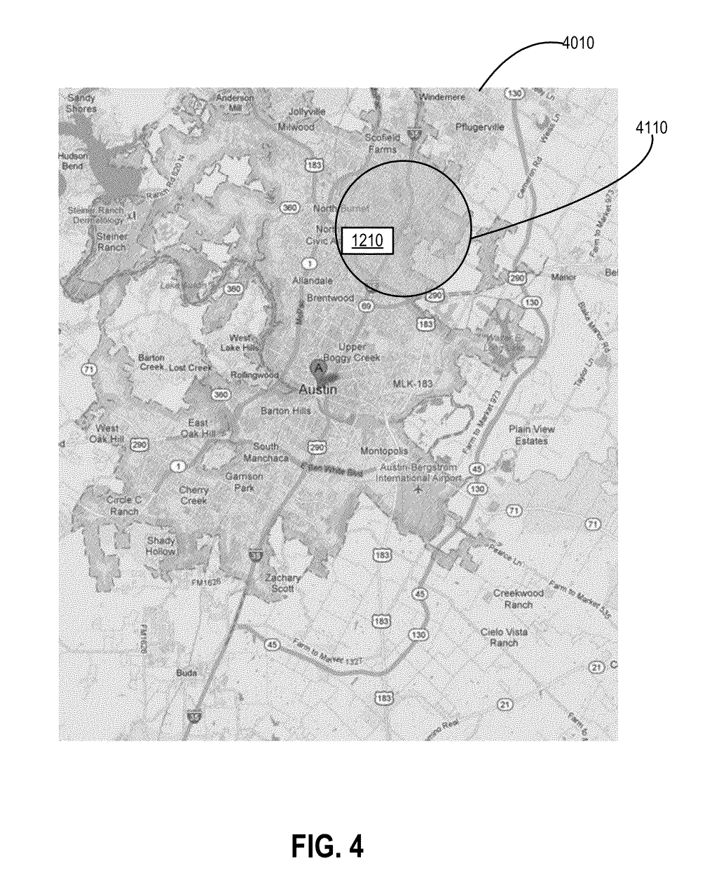

In one or more embodiments, the map can include the location, received at 3010, and one or more surrounding regions. For example, a map 4010 can include the location of Austin, Tex. and one or more surrounding regions as illustrated in FIG. 4. For instance, the client can display map 4010, via a display device and/or a graphical user interface (GUI), to a user. At 3030, input indicating a search region can be received. For example, an API server of API servers 2020-2024 can receive input indicating the search region from the client via network 1010. For instance, the user can select a search region 4110 of map 4010, and input indicating search region 4110 can be received from the client via network 1010. In one or more embodiments, the input indicating the search region received at 3030 can be associated with the location received via the input at 3010. As illustrated, search region 4110 can include location 1210.

At 3040, it can be determined if there is another search region. If there is another search region, the method can proceed to 3030. In one or more embodiments, a user of the client can utilized a GUI in selecting one or more search regions. In one instance, the client can receive user input via a pointing device (e.g., a mouse, a track pad, a track ball, a stylus, a finger, etc.), and data associated with and/or corresponding to the one or more selected search regions. In another instance, selected one or more search regions can be displayed, to a user, via a display device and/or a GUI.

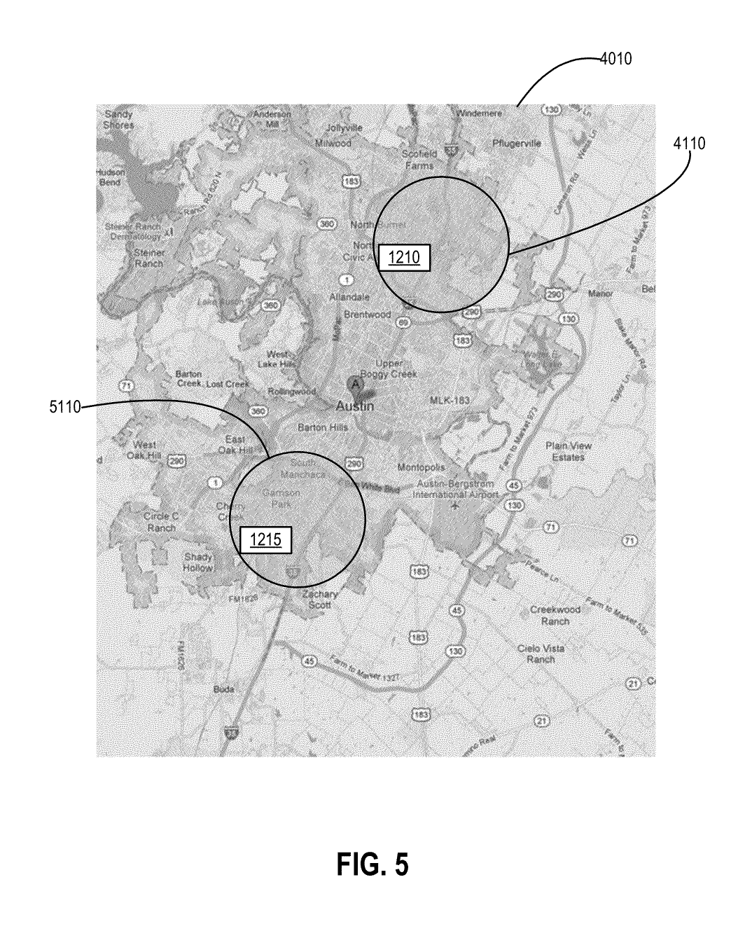

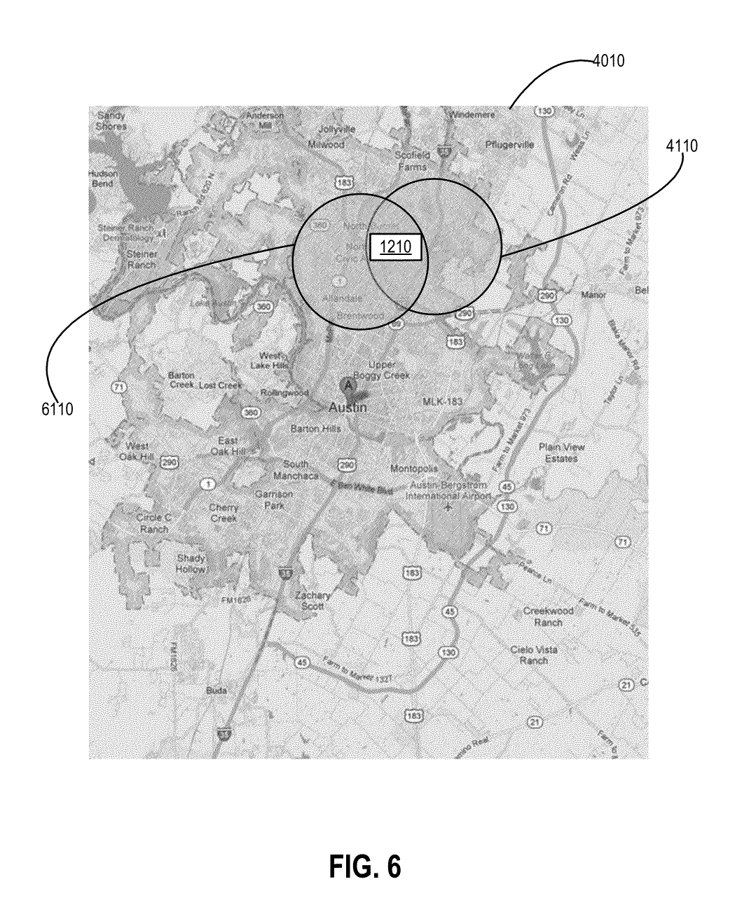

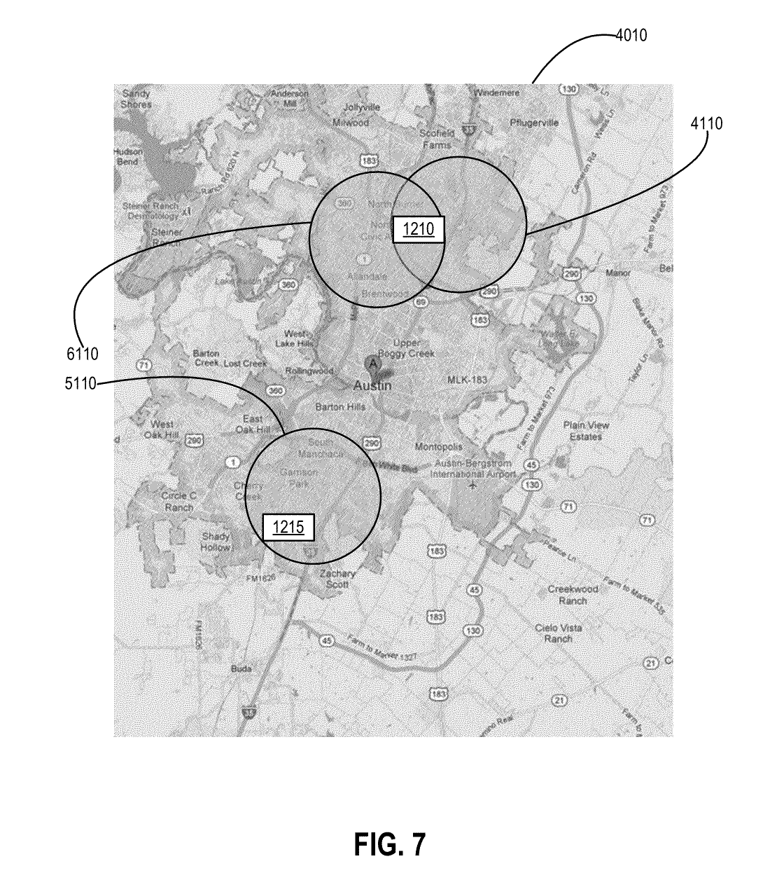

In one example, another search region can be selected. For instance, a search region 5110, as shown in FIG. 5, can be selected in addition to search region 4110, and input indicating search region 5110 can be received from the client via network 1010. As illustrated, search region 5110 can include location 1215. In a second example, another search region can be selected. For instance, a search region 6110, as shown in FIG. 6, can be selected in addition to search region 4110, and input indicating search region 6110 can be received from the client via network 1010. As illustrated in FIG. 6, one search region can overlap with another search region. In another example, multiple search regions can be selected. For instance, search regions 4110, 5110, and 6110 can be selected as shown in FIG. 7, and input indicating search regions 4110, 5110, and 6110 can be received from the client via network 1010.

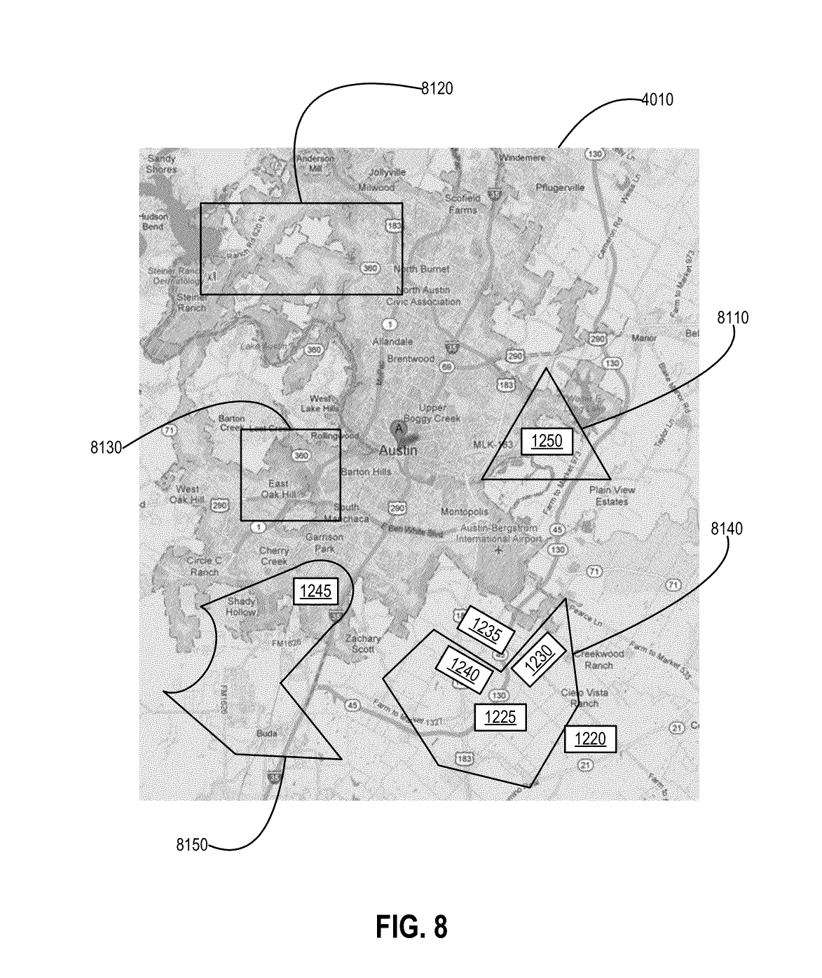

In one or more embodiments, a search region can include one or more shapes and/or boundaries. For example, a search region can include a polygon. In one instance, a search region can include a triangular search region, such as a search region 8110 of FIG. 8. As illustrated search region 8110 can include location 1250. In a second instance, a search region can include a rectangular search region, such as a search region 8120 of FIG. 8. In a third instance, a search region can include a square search region, such as a search region 8130 of FIG. 8. In a fourth instance, a search region can include custom search region (e.g., a n-sided polygon), such as a search region 8140 of FIG. 8. As illustrated, search region 8140 can include locations 1225, 1230, and 1240.

In another instance, a search region can include a custom search region (e.g., one or more straight edges with one or more arcs, elliptical arcs, parabolic arcs, splines, etc.), such as a search region 8150 of FIG. 8. As illustrated search region 8150 can include location 1245. In one or more embodiments, a custom search region can be utilized in implementing a search region of one or more of a voting district, a congressional district, a school district, a school, a campus, a dormitory, a police precinct, a piece of real estate, a neighborhood, a borrow, a city, a town, a commercial office building, a factory, a refinery, a storage facility, a power station, a power substation, and a military installation, among others.

In one or more embodiments, a custom search region can be described, transmitted, and/or stored via a markup language and/or a data description language. In one example, a custom search region can be described, transmitted, and/or stored via an extensible markup language (XML). In a second example, a custom search region can be described, transmitted, and/or stored via a keyhole markup language (KML). In another example, a custom search region can be described, transmitted, and/or stored via a language that can represent data structures (e.g., objects, arrays, associative arrays, etc.). For instance, the language that can represent data structures can be or include JSON (JavaScript Object Notation). In one or more embodiments, JSON can be utilized by any language that can support and/or utilize a JSON lexer and/or parser.

If there is not another search region, the method can proceed to 3050, as shown in FIG. 3, where input indicating a data search can be received. For example, the input indicating a data search can include one or more of a word, words, a phrase, a user profile, a portion of a user profile, a regular expression, a natural language filter, a grammar, a social group, an organization, and a user identification, among others. For instance, the input indicating a data search can be received from the client via network 1010. In one or more embodiments, the input indicating a data search can be or include search data. For example, the search data can include one or more of a word, words, a phrase, a user profile, a portion of a user profile, a regular expression, a natural language filter, a grammar, a social group, an organization, and a user identification, among others.

At 3055, it can be determined if there is additional search data. If there is additional search data, the method can proceed to 3050. If there is not additional search data, the method can proceed to 3060, where one or more queries can be generated. In one example, generating the one or more queries can include multiple supported geographical search region shapes. For instance, a search region can include one or more shapes that are not supported by one or more social media data sources, and the multiple supported geographical search region shapes can include the one or more shapes that are not supported by one or more social network media data sources. In a second example, the one or more queries can be based on one or more of the search region, the user input indicating a data search (e.g., search data), and one or more social network media data sources that store user-provided data (e.g., user input, user-provided content, social network user-provided data, social network user-provided content) from multiple users provided via multiple user computing devices at multiple locations (e.g., two or more of CDs 1110-1126 at respective locations 1210-1250), among others.

In another example, generating the one or more queries can include configuring and/or implementing the one or more queries with one or more a word, multiple words, a phrase, a user profile, a portion of a user profile, a regular expression, a natural language filter, a grammar, a social group, an organization, and a user identification, among others. In one instance, the one or more of the word, the multiple words, the phrase, the user profile, the portion of the user profile, the regular expression, the natural language filter, the grammar, the social group, the organization, and the user identification, among others, can match at least a portion of the user-provided data (e.g., user input, user-provided content, social network user-provided data, social network user-provided content) from multiple users provided via multiple user computing devices at multiple locations and/or can produce one or more search results. In another instance, one or more search results can be produced and/or generated via a satisfaction and/or a statistical satisfaction of one or more criteria that can include and/or can be based on the one or more of the word, the multiple words, the phrase, the user profile, the portion of the user profile, the regular expression, the natural language filter, the grammar, the social group, the organization, and the user identification, among others.

At 3070, the one or more queries can be provided to one or more social media data sources. In one example, one or more of API servers 2020-2024 can provide the one or more queries to one or more social media data sources, via network 1010. For instance, one or more of API servers 2020-2024 can query one or more social media data sources 1610-1640 based on the search data and the one or more search regions. In another example, one or more of application servers 2040-2050 can provide the one or more queries to one or more social media data sources, via network 1010. For instance, one or more of application servers 2040-2050 can query one or more social media data sources 1610-1640 based on the search data and the one or more search regions.

At 3080, one or more results of the query of the one or more social media data sources can be received. In one example, one or more of API servers 2020-2024 can receive one or more results of the query of one or more social media data sources 1610-1640 via network 1010. In another example, one or more of application servers 2040-2050 can receive one or more results of the query of one or more social media data sources 1610-1640 via network 1010. At 3090, the one or more results of the query of the one or more social media data sources can be stored. For example, a database can store the results of the query of the social media data sources. For instance, one or more of databases 2030-2034 can store the results of the query of social media data sources 1610-1640.

At 3100, the one or more results of the query of the one or more social media data sources can be provided to the client. In one example, one or more of API servers 2020-2024 can provide the results of the query of social media data sources 1610-1640 to the client via network 1010. In another example, one or more of application servers 2040-050 can provide the results of the query of social media data sources 1610-1640 to the client via network 1010.

In one or more embodiments, one or more locations (e.g., one or more locations where user data was provided by one or more users via one or more of their computing devices) can correspond to the one or more results of the one or more queries. In one example, location 1210 (as shown in FIG. 4), e.g., a location where user data was provided by one or more users via one or more of their computing devices, can correspond to the one or more results of the one or more queries, and the client can display location 1210 to a user, via a display device and/or a GUI. In a second example, locations 1210 and 1215 (as shown in FIG. 5), e.g., one or more locations where user data was provided by one or more users via one or more of their computing devices, can correspond to the one or more results of the one or more queries, and the client can display locations 1210 and 1215 to a user, via a display device and/or a GUI.

In a third example, location 1210 (as shown in FIG. 6) e.g., a location where user data was provided by one or more users via one or more of their computing devices, can correspond to the one or more results of the one or more queries, and the client can display location 1210 to a user, via a display device and/or a GUI. For instance, the one or more queries can include multiple search regions 4110 and 6110. In a fourth example, one or more of locations 1210 and 1215 (as shown in FIG. 7), e.g., one or more locations where user data was provided by one or more users via one or more of their computing devices, can correspond to the one or more results of the one or more queries, and the client can display to a user, via a display device and/or a GUI. For instance, the one or more queries can include one or more of search regions 4110, 5110, and 6110.

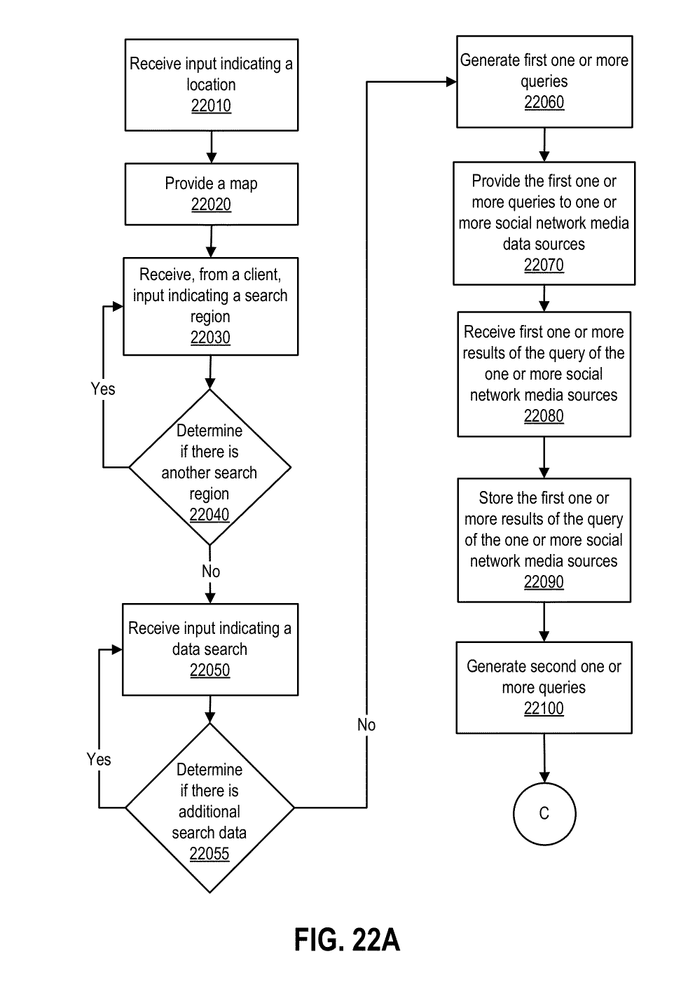

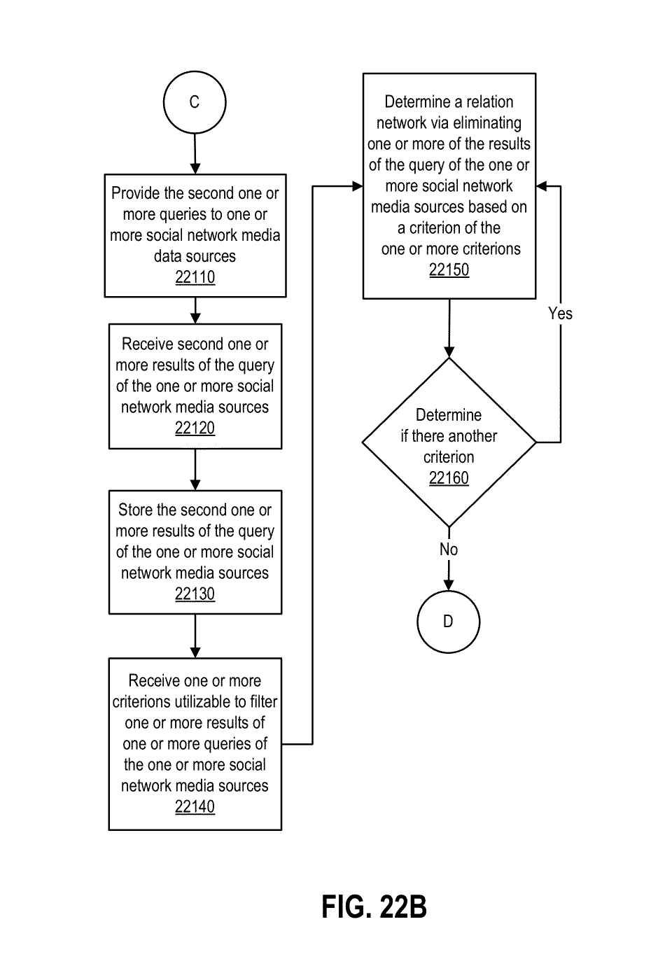

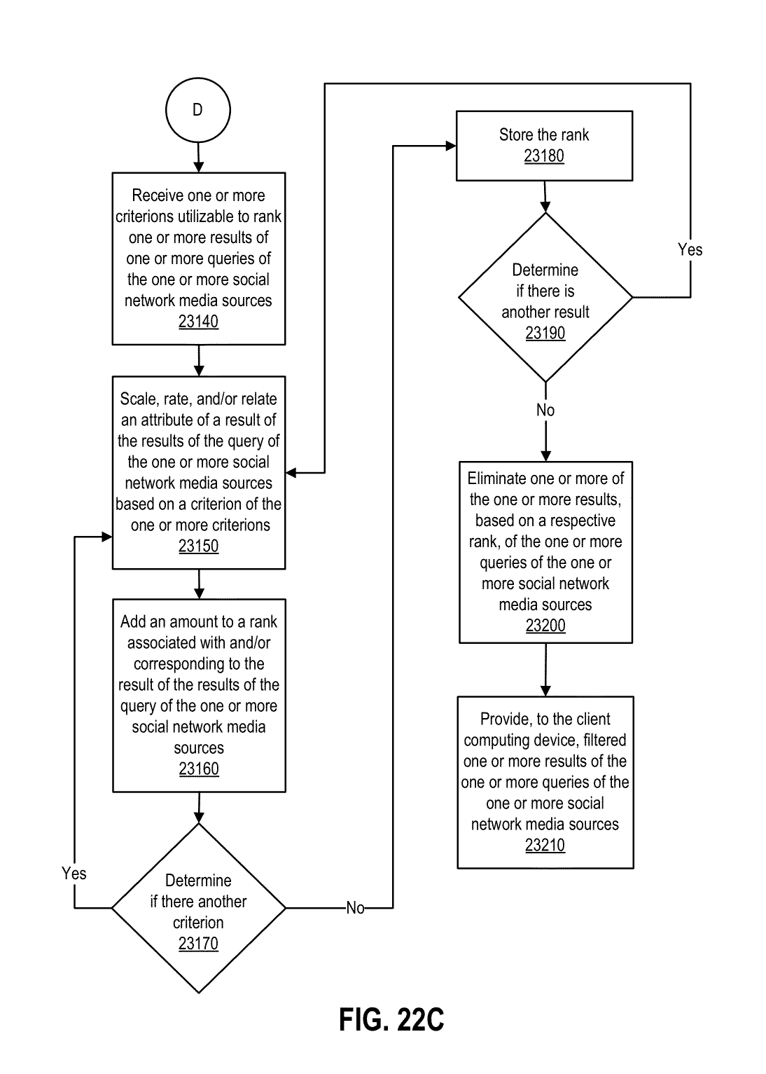

In a fifth example, one or more of locations 1225, 1230, 1240, 1245, and 1250 (as shown in FIG. 8), e.g., one or more locations where user data was provided by one or more users via one or more of their computing devices, can correspond to the one or more results of the one or more queries, and the client can display to a user, via a display device and/or a GUI. For instance, the one or more queries can include one or more of search regions 8110, 8120, 8130, and 8140. In another example, one or more of locations 22210-22232 (as shown in FIG. 22), e.g., one or more locations where user data was provided by one or more users via one or more of their computing devices, can correspond to the one or more results of the one or more queries. For instance, the client can display to a user, via a display device and/or a GUI, one or more locations 22210-22232 via a search region 22110 and/or via a map 22010.

In one or more embodiments, the one or more results of the query of the one or more social media data sources can be analyzed by the one or more of API servers 2020-2024 and/or one or more of application servers 2040-050 to provide analysis and/or conclusions about the results of the query of social media data sources 1610-1640. For example, the one or more results of the query of the one or more social media data sources can be filtered by one or more of API servers 2020-2024 and/or one or more of application servers 2040-050 to provide filtered results and/or analysis of the one or more queries of social media data sources 1610-1640 that include one or more of an identified word, phrase, user profile, portion of a user profile, regular expression, grammar, social group, organization, user identification, and a location, among others.

In one or more embodiments, a search region can include a shape that is not supported by one or more social media data sources. For example, one or more social media data sources may support one or more shapes for defining a search region but not other shapes. For instance, one or more social media data sources may support a circular search region (e.g., a location and a radius from the location). In this instance, search regions 4110-6110 can be supported by one or more social media data sources, while search regions 8110-8150 may not be supported. In one or more embodiments, a query of one or more social network media data sources for a search region that is not supported by one or more social media data sources can be performed. For example, one or more queries can be generated utilizing multiple of the one or more shapes defining search regions that can be supported by the one or more social media data sources in order to generate the one or more queries of a search region including a shape that is not supported by one or more social media data sources. For instance, multiple shapes of search regions that can be supported by the one or more social media data sources can be utilized to implement and/or support a search region shape that is not supported by the one or more social media data sources.

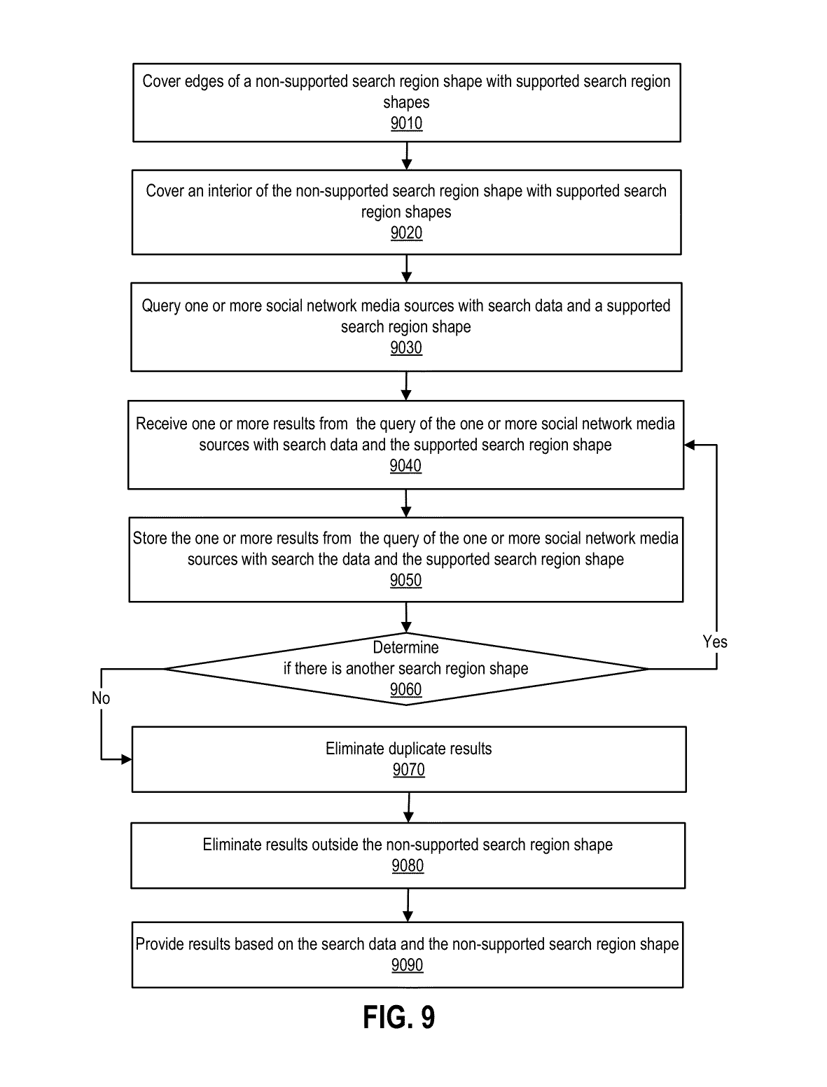

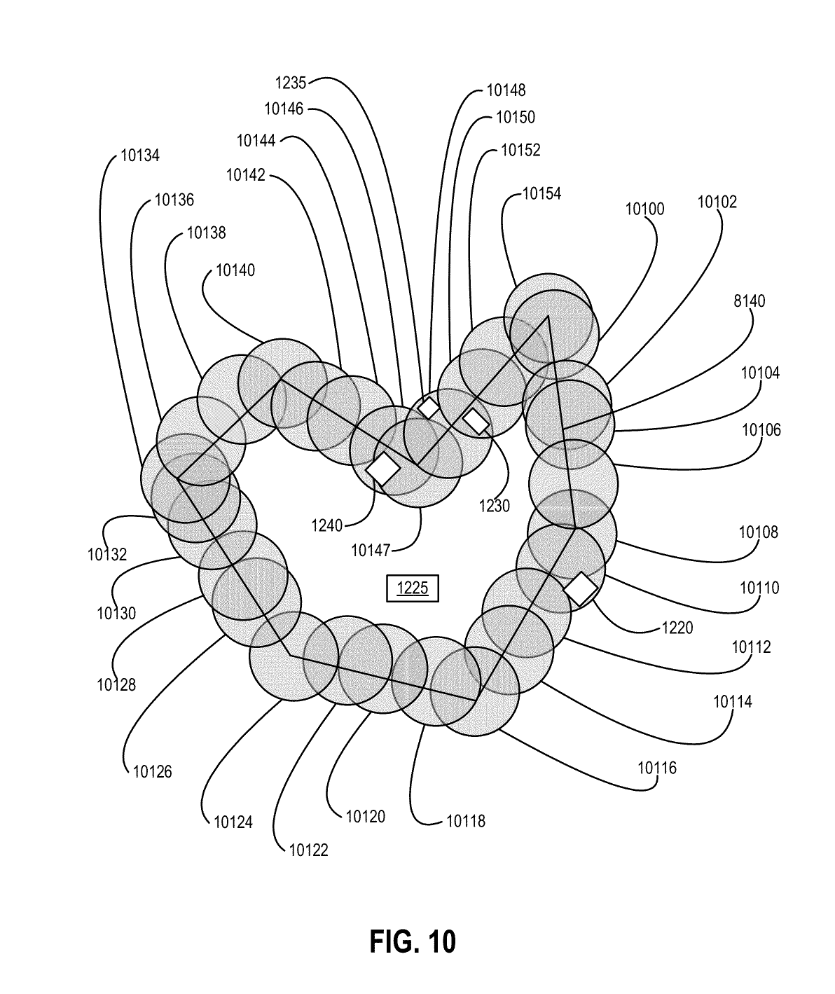

Turning now to FIG. 9, an exemplary method of supporting a search region shape that is not supported by one or more social media data sources is illustrated, according to one or more embodiments. At 9010, edges of a custom search region shape can be covered by shapes of search regions that are supported by a social media data source. For example, as illustrated in FIG. 10, search region 8140 is a custom search region shape, and edges of search region 8140 can be covered by circular search regions 10100-10154, which are supported search region shapes, in some examples.

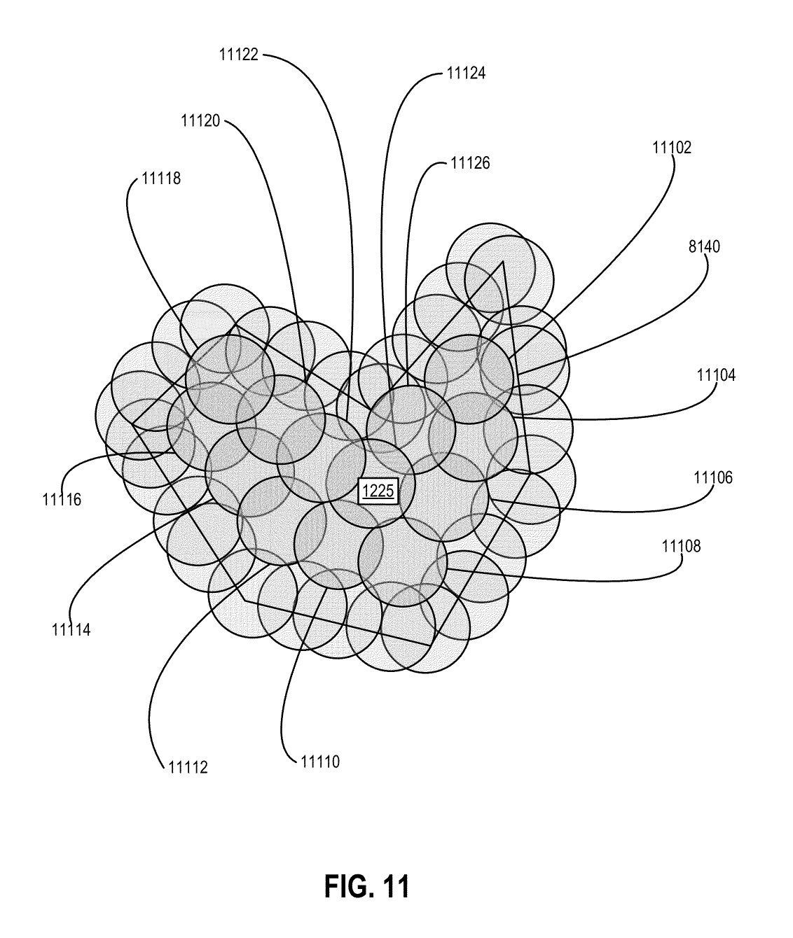

At 9020, an interior of the custom search region shape can be covered by shapes of search regions that are supported by a social media data source. For example, search region 8140 is a custom search region shape, and an interior of search region 8140 can be covered by circular search regions 11102-11126 that are supported search region shapes, as illustrated in FIG. 11. For instance, search region 11124 includes location 1225.

At 9030, one or more social network media data sources can be queried. For example, the query can include search data and a supported search region. For instance, the search data can include one or more of a word, a phrase, a user profile, a portion of a user profile, a social group, an organization, a user identification, a regular expression, and a grammar, among others, and the supported search region can include a search region of search regions 10100-11126. At 9040, one or more results of the query, associated with and/or corresponding to the supported search region, can be received. At 9050, the one or more results of the query can be stored.

At 9050, it can be determined if there is another search region shape. If there is another search region shape, the method can proceed to 9040. If there is not another search region shape, the method can proceed to 9070, where one or more duplicates of the search results can be eliminated.

In one or more embodiments, two or more of the supported search region shapes can intersect, and those intersections can yield duplicates in results of the queries based on respective search region shapes. For example, search regions 10148 and 10150 intersect and can produce one or more duplicates in search data results, since an area of an intersection of search regions 10148 and 10150 can be searched multiple times. For instance, search regions 10148 and 10150 intersect and include location 1230, as illustrated in FIG. 10, and one or more duplicates of the search data results of an intersection of search regions 10148 and 10150 can be eliminated.

At 9080, one or more results that correspond to one or more locations outside the custom search region shape can be eliminated. For example, one or more locations that are outside one or more edges of search region 8140 can be eliminated. For instance, search region 10110 can include one or more locations outside one or more edges of search region 8140, and results associated with and/or corresponding to the one or more locations outside one or more edges of search region 8140 can be eliminated. As illustrated in FIG. 10, search region 10110 can include location 1220, and location 1220 is outside one or more edges of search region 8140. As such, one or more results associated with and/or corresponding to location 1220 can be eliminated as falling outside the boundary of the custom search region shape. At 9090, one or more results based on the search data and the custom search region shape can be provided to the client.

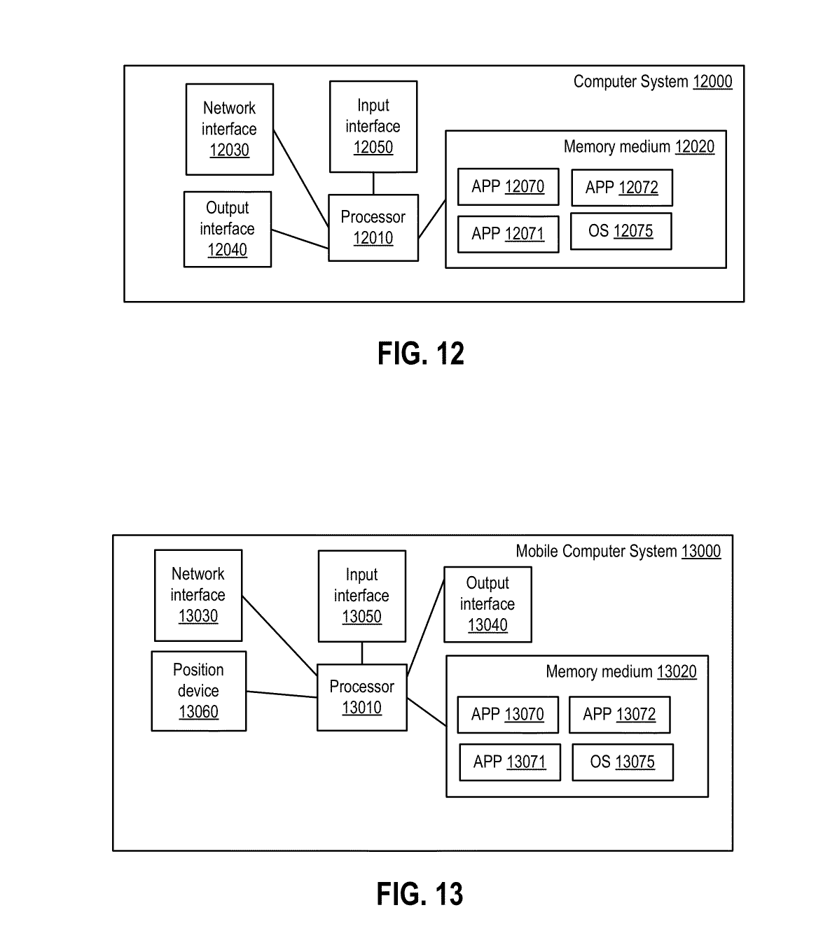

Turning now to FIG. 12, a computer system is illustrated, according to one or more embodiments. As shown, a computer system 12000 can include a processor 12010 coupled to a memory medium 12020. In one or more embodiments, processor 12010 can include and/or implement an instruction set architecture (ISA) that can include instructions that can be stored via memory medium 12020 and/or can be executable by processor 12010

As illustrated, memory medium can include one or more applications (APPs) 12070-12072 and an operating system (OS) 12075. In one or more embodiments, one or more of APPs 12070-12072 and OS 12075 can store instructions, executable by processor 12010, that can include one or more software programs in accordance with one or more of methods, processes and/or flowcharts described herein.

As illustrated, computer system 12000 can include a network interface 12030 coupled to processor 12010. In one example, network interface 12030 can be configured to couple computer system 12000 to network 1010. In a second example, network interface 12030 can be configured to couple computer system 12000 to a wireless AP. In a third example, network interface 12030 can be configured to couple computer system 12000 to a wired AP or gateway (e.g., a cable modem, a DSL modem, a router, a switch, etc.). In another example, network interface 12030 can be configured to couple computer system 12000 to a wireless telephone network (e.g., a cellular telephone network, a satellite telephone network, etc.).

As shown, computer system 12000 can include an output interface 12040 coupled to processor 12010. In one example, output interface 12040 can include a display that can convey graphical information to a user. In another example, output interface 12040 can be configured to be coupled to a display that can convey graphical information to a user. In another example, output interface 12040 can include or can be configured to be coupled to an audio output device (e.g., a speaker).

As illustrated, computer system 12000 can include an input interface 12050. In one example, input interface 12050 can include one or more of a keyboard and a mouse, among others. In a second example, input interface 12050 can be configured to be coupled to one or more of a keyboard and a mouse, among others. In a third example, input interface 12050 can include an input of a touch screen. In a fourth example, input interface 12050 can include or can be configured to be coupled to an audio input device (e.g., a microphone). In another example, input interface 12050 can be configured to be coupled to an input of a touch screen. In one or more embodiments, one or more of CDs 1110-1132, API servers 2020-2024, databases 2030-2034, and application servers 2040-2050 can include one or more structures and/or functionalities described with reference to computer system 12000.

In one or more embodiments, a computer system can include a field programmable gate array (FPGA) coupled to a memory medium, and the memory medium can store data and/or configuration information that can be utilized by the FPGA in implementing one or more systems, methods, and/or processes described herein. For example, the configuration information and/or the one or more instructions can include a hardware description language and/or a schematic design that can be utilized by the FPGA to implement one or more systems, methods, and/or processes described herein. In one or more embodiments, the FPGA can include multiple programmable logic components that can be configured and coupled to one another in implementing one or more systems, methods, and/or processes described herein.

In one or more embodiments, the FPGA can be coupled to one or more of a network interface, an output interface, and an input interface. In one or more embodiments, one or more of the network interface, the output interface, and the input interface can provide and/or implement one or more structures and/or functionalities as described above.

In one or more embodiments, a computer system can include an application specific processor (ASIC) coupled to a memory medium. In one or more embodiments, the memory medium can store data and/or configuration information that can be utilized by the ASIC in implementing one or more systems, methods, and/or processes described herein. For example, the memory medium can store a configuration, and the configuration can include configuration information and/or one or more instructions that can be utilized by the ASIC to implement one or more systems, methods, and/or processes described herein. In one or more embodiments, the memory medium can store data and/or instructions that can be executed by the ASIC. For instance, one or more APPs and/or an OS can include instructions of an ISA associated with the ASIC.

In one or more embodiments, the ASIC can be coupled to one or more of a network interface, an output interface, and an input interface. In one or more embodiments, one or more of the network interface, the output interface, and the input interface can provide and/or implement one or more structures and/or functionalities as described above.

In one or more embodiments, a computer system can include graphics processing unit (GPU) coupled to a memory medium. For example, the GPU can be or include a general purpose graphics processing unit (GPGPU). In one or more embodiments, the memory medium can store data and/or configuration information that can be utilized by the GPU in implementing one or more systems, methods, and/or processes described herein. For example, the memory medium can store a configuration, and the configuration can include configuration information and/or one or more instructions that can be utilized by the GPU to implement one or more systems, methods, and/or processes described herein.

In one or more embodiments, the GPU can be coupled to one or more of a network interface, an output interface, and an input interface. In one or more embodiments, one or more of the network interface, the output interface, and the input interface can provide and/or implement one or more structures and/or functionalities as described above.

Turning now to FIG. 13, a mobile computer system is illustrated, according to one or more embodiments. As shown, a mobile computer system 13000 can include a processor 13010 coupled to a memory medium 13020. As illustrated, memory medium can include one or more APPs 13070-13072 and an OS 13075. In one or more embodiments, one or more of APPs 13070-13072 and OS 13075 can store instructions, executable by processor 13010, that can include one or more software programs in accordance with one or more of methods, processes and/or flowcharts described herein.

As illustrated, mobile computer system 13000 can include a network interface 13030 coupled to processor 12010. In one example, network interface 13030 can be configured to couple mobile computer system 13000 to network 1010. In a second example, network interface 13030 can be configured to couple mobile computer system 13000 to a wireless AP. In a third example, network interface 13030 can be configured to couple mobile computer system 13000 to a wired AP or gateway (e.g., a cable modem, a DSL modem, a router, a switch, etc.). In another example, network interface 13030 can be configured to couple computer system 13000 to a wireless telephone network (e.g., a cellular telephone network, a satellite telephone network, etc.).

As shown, mobile computer system 13000 can include an output interface 13040 coupled to processor 13010. In one example, output interface 12040 can include a display that can convey graphical information to a user. In another example, output interface 13040 can be configured to be coupled to a display that can convey graphical information to a user. In another example, output interface 13040 can include or can be configured to be coupled to an audio output device (e.g., a speaker).

As illustrated, mobile computer system 13000 can include an input interface 13050. In one example, input interface 13050 can include one or more of a keyboard and a mouse, among others. In a second example, input interface 13050 can be configured to be coupled to one or more of a keyboard and a mouse, among others. In a third example, input interface 13050 can include an input of a touch screen. In a fourth example, input interface 13050 can include or can be configured to be coupled to an audio input device (e.g., a microphone). In another example, input interface 13050 can be configured to be coupled to an input of a touch screen.

As shown, mobile computer system 13000 can include a position device 13060 coupled to processor 13010. For example, position device 13060 can determine location information and/or provide the location information to processor 13010. For instance, position device 13060 can determine location information based on one or more of multilateration, trilateration, triangulation, and multiangulation, among others. In one or more embodiments, position device 13060 can include a GPS device and/or mechanism. For example, a GPS device and/or mechanism can determine location information and provide the determined location information to processor 13010. In one or more embodiments, one or more of CDs 1110-1132 can include one or more structures and/or functionalities described with reference to mobile computer system 13000.

In one or more embodiments, mobile computer system 13000 may not include position device 13060. For example, position device 13060 can be eliminated from a design and/or implementation of mobile computer system 13000 to conserve utilization of a power source of mobile computer system 13000.

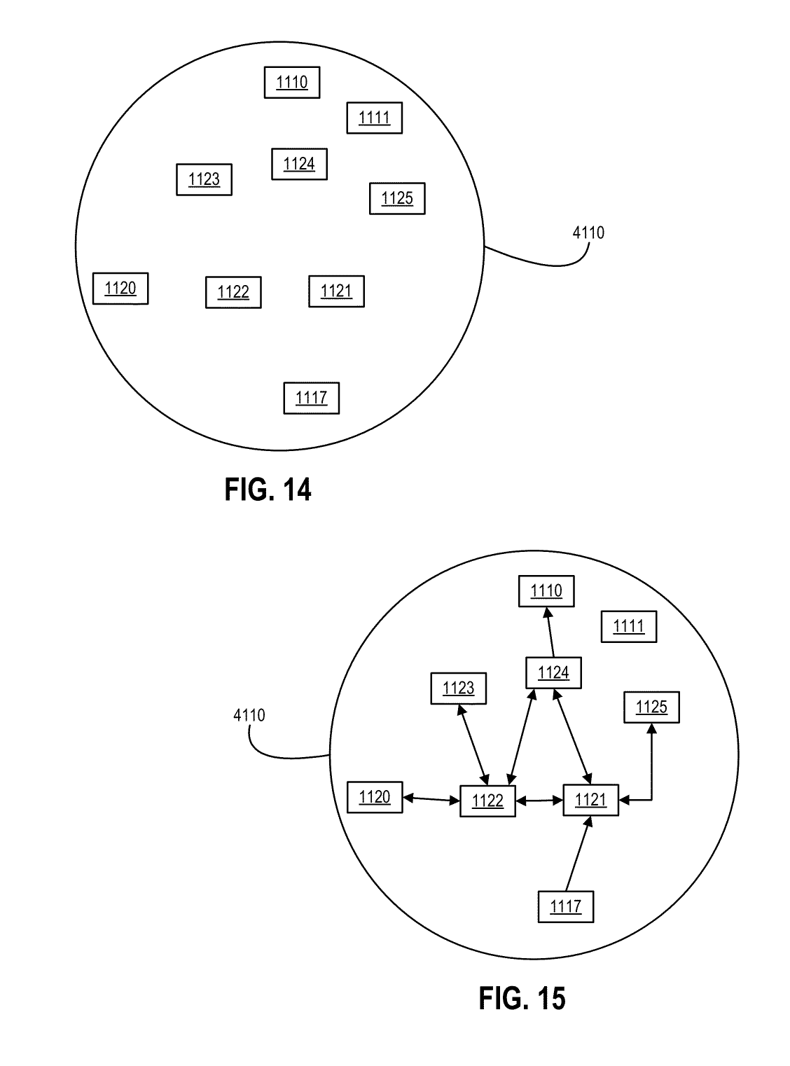

Turning now to FIG. 14, an exemplary diagram of a search region that includes one or more computing devices is illustrated, according to one or more embodiments. As illustrated, geographical search region 4110 can include one or more of CDs 1110, 1111, 1117, and 1120-1125. In one or more embodiments, one or more networks of users and/or accounts of users associated with geographical search region 4110 can be determined. For example, communications among the users and/or accounts of users associated with geographical search region 4110 can be analyzed to determine the one or more networks of users (e.g., a social network) and/or accounts of users associated with geographical search region 4110.

In one or more embodiments, one or more of a number of communications, one or more directions of communications, and one or more numbers of followers, among others, can be utilized in determining one or more networks of users and/or accounts of users associated with a search region. In one example, two users can chat with each other. For instance, one or more bidirectional communications can include one or more chats between two users.

In a second example, a user can post one or more messages to a messaging service and one or more other users can receive the one or more messages from the user via the messaging service. In one instance, a user can post one or more messages to Twitter and one or more other users can receive the one or more messages from the user via Twitter, where the one or more other users (e.g., followers of the user) subscribe to receiving the one or more messages of the user. In a second instance, a user can post one or more messages, to Twitter, associated with a keyword and/or topic and one or more other users can receive the one or more messages from the user via Twitter, where the one or more other users subscribe to messages associated with the keyword and/or topic. In another instance, a user can post one or more messages to Facebook and one or more other users can receive the one or more messages from the user via Facebook, where the one or more other users are “friends” of the user.

FIG. 15 illustrates, for example, a network of users and/or accounts of users associated with geographical search region 4110. In one or more embodiments, a relation network can include a network of users and/or accounts of users. For example, a relation network associated with geographical search region 4110 can include users and/or accounts of users associated with CDs 1120-1125.

As shown in FIG. 15, bidirectional communications (e.g., represented via double-ended arrows) can be utilized in determining a relation network associated with geographical search region 4110 that can include users and/or accounts of users associated with CDs 1120-1125. In one or more embodiments, bidirectional communication can include multiple communications between two different users and/or two different user accounts.

In one example, a first user can subscribe to messages posted by a second user, different from the first user, and the second user can subscribe to messages posted by the first user. In a second example, a first user and a second user, different from the first user, can participate in a chat. In another example, a first user and a second user, different from the first user, can post information updates and receive information updates of one another. For instance, the first user and the second user can be “friends” on Facebook, and the first user and the second user can post respective information updates and receive information updates of one another.

As illustrated in FIG. 15, single direction communications (e.g., represented via single-ended arrows) can be utilized in determining a relation network associated with geographical search region 4110 that can include users and/or accounts of users associated with CDs 1110 and 1117. In one or more embodiments, single communication can include one or more communications from one user and/or one user account to one or more other users and/or to one or more other user accounts.

In one example, a user can post one or more messages, and one or more other users can receive the one or more messages posted by the user. For instance, one or more other users can subscribe to communications provided by the user. In another example, one or more users can provide communications to a user, and the user may not provide communications to the one or more users. In one instance, the one or more users can post communications (e.g., tweets) to Twitter (which the user receives), and the user may not provide communications to the one or more users. In another instance, the one or more users can post communications on a “Facebook wall” of the user, and the user may not provide communications to the one or more users.

As shown, CD 1111 may not communicate with another computing device associated with geographical search region 4110. For example, a user of CD 1111 and/or an account of the user may not be included in a relation network.

In one or more embodiments, users and/or accounts of users associated with a geographic search region that are not included in a relation network associated with a geographic search region can be eliminated and/or ignored in an analysis associated with and/or based on the geographic search region. For example, users and/or accounts of users associated with geographical search region 4110 and respective CDs 1110, 1111, and 1117 can be eliminated and/or ignored in an analysis associated with and/or based on geographical search region 4110. In one instance, one or more users and/or accounts of users associated with geographical search region 4110 and respective CDs 1110 and 1117 can be eliminated and/or ignored, as they do not correspond with bidirectional communications with any other computing device associated with geographical search region 4110. In another instance, a user and/or an account of the user associated with geographical search region 4110 and CD 1111 can be eliminated and/or ignored, as it does not communicate with any other computing device associated with geographical search region 4110 and/or can be an outlier, a visitor, and/or a passer-by with respect to geographical search region 4110.

In one or more embodiments, determining one or more of bidirectional communication and non-bidirectional communication can include determining one or more of bidirectional communication and non-bidirectional communication that occurs within an amount of time and/or within a time period of a history. In one example, determining one or more of bidirectional communication and non-bidirectional communication can include determining one or more of bidirectional communication and non-bidirectional communication that occurs within a seven day time period, two months ago. In a second example, determining one or more of bidirectional communication and non-bidirectional communication can include determining one or more of bidirectional communication and non-bidirectional communication that occurs within a last five days. In another example, determining one or more of bidirectional communication and non-bidirectional communication can include determining one or more of bidirectional communication and non-bidirectional communication that occurs within a twenty hour time period, three days ago.

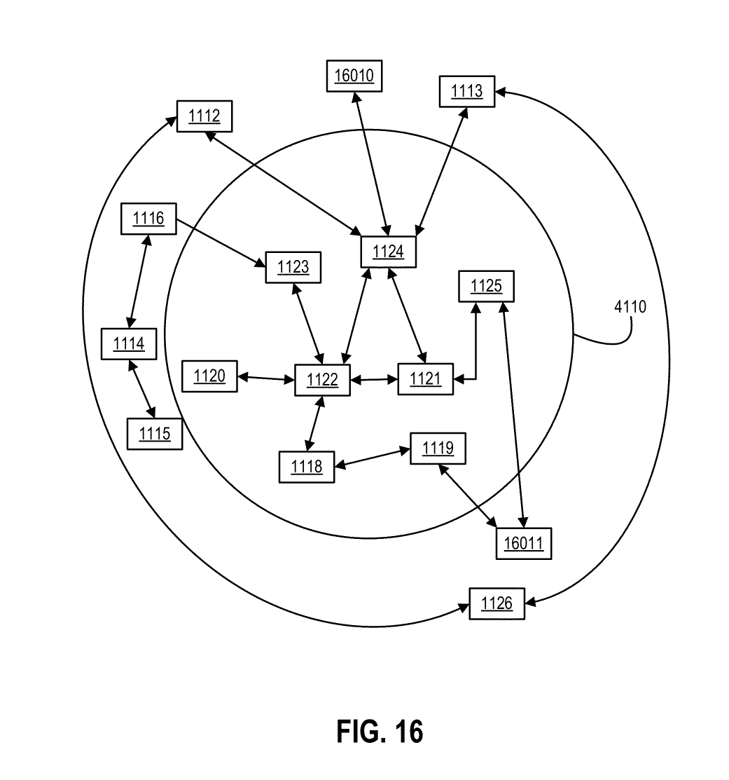

Turning now to FIG. 16, an exemplary diagram of a first determined relation network that includes one or more computing devices is illustrated, according to one or more embodiments. In one or more embodiments, illustrating communications among computing devices can illustrate communications among users of the respective computing devices and/or accounts of users of the respective computing devices. For example, illustrating communications among computing devices can illustrate a relation network of users that utilize the respective computing devices and/or accounts of users that utilize the respective computing devices.

As illustrated, arrows can indicate directions of relation network communications among users and/or accounts of users associated with respective CDs 1112-1116, 1118, 1119, 1120-1126, 16010, and 16011. For example, communications among users and/or accounts of users associated with respective CDs 1112-1116, 1118, 1119, 1120-1126, 16010, and 16011 can be utilized in determining a relation network and/or determining locations of computing devices that may not provide one or more locations when communicating.

In one or more embodiments, a user and/or an account of a user associated with a computing device may not provide a location when communicating. In one example, a user and/or an account of user associated with CD 1118 may not provide a location when communicating. In a second example, one or more locations of a user and/or an account of user associated with CD 1119 may not be determined when CD 1119 communicates. In another example, one or more locations of a user and/or an account of user associated with CD 1119 may not be provided, via a network provider (e.g., a social network providers, a communications network providers, etc.), when CD 1119 communicates.

In one or more embodiments, a location of a computing device of a user can be determined via utilizing communications of the user and/or communications of an account of the user. In one example, a location of CD 1118 can be determined via utilizing communications of a user of CD 1118 and/or communications of an account of the user of CD 1118. For instance, if bidirectional communications have occurred between a user of CD 1118 and/or an account of the user of CD 1118 and a user of CD 1122 and/or an account of the user of CD 1122, where a location of CD 1122 has been determined to be within geographical search region 4110, then CD 1118 can be determined to be within and/or associated with geographical search region 4110. In another example, a location of CD 1119 can be determined via utilizing communications of a user of CD 1119 and/or communications of an account of the user of CD 1119. For instance, if bidirectional communications have occurred between a user of CD 1119 and/or an account of the user of CD 1119 and a user of CD 1118 and/or an account of the user of CD 1118, where a location of CD 1118 has been determined to be within and/or associated with geographical search region 4110, then CD 1119 can be determined to be within and/or associated with geographical search region 4110.

In one or more embodiments, a location of a computing device of a user can be determined via utilizing one or more attributes of the user and/or an account of the user. For example, a location of a computing device of a user can be determined via determining how well connected the user and/or the account of the user is to a relation network. In one instance, a location of CD 1118 can be determined via determining that one or more attributes, associated with the user and/or the account of the user, are sufficiently connected to a relation network associated with geographical search region 4110. In another instance, a location of CD 1119 can be determined via determining that one or more attributes, associated with the user and/or the account of the user, are sufficiently connected to a relation network associated with geographical search region 4110. In one or more embodiments, a relation network can be based on one or more criterions (e.g., parameters).

As illustrated, a determined relation network that includes one or more computing devices can include one or more computing devices that are not included in and/or associated with geographical search region 4110, according to one or more embodiments. For example, one or more of CDs 1114-1116, 16010, and 16011 can be included in the relation network.

In one instance, CD 16010 can be included in the relation network, since a user of CD 16010 and/or an account of the user of CD 16010 and a user of CD 1124 and/or an account of the user of CD 1124 communicate bidirectionally. In a second instance, CD 1116 can be included in the relation network, since a user of CD 1116 and/or an account of the user of CD 1116 and a user of CD 1123 and/or an account of the user of CD 1123 communicate in a single direction. In a third instance, CD 1114 can be included in the relation network, since a user of CD 1114 and/or an account of the user of CD 1114 and a user of CD 1116 and/or an account of the user of CD 1116 communicate bidirectionally. In a third instance, CD 1115 can be included in the relation network, since a user of CD 1115 and/or an account of the user of CD 1115 and a user of CD 1114 and/or an account of the user of CD 1114 communicate bidirectionally. In a fourth instance, CDs 1112 and 1113 can be included in the relation network, since respective users of CDs 1112 and 1113 and/or respective accounts of the respective users of CDs 1112 and 1113 and a user of CD 1124 and/or an account of the user of CD 1124 communicate bidirectionally. In a fifth instance, CD 1126 can be included in the relation network, since a user of CD 1126 and/or an account of the user of CD 1126 and one or more of respective users of CDs 1112 and 1113 and/or respective accounts of the respective users of CDs 1112 and 1113 communicate bidirectionally. In another instance, CD 16011 can be included in the relation network, since a user of CD 16011 and/or an account of the user of CD 16011 and one or more of respective users of CDs 1119 and 1125 and/or respective accounts of the respective users of CDs 1119 and 1125 communicate bidirectionally.

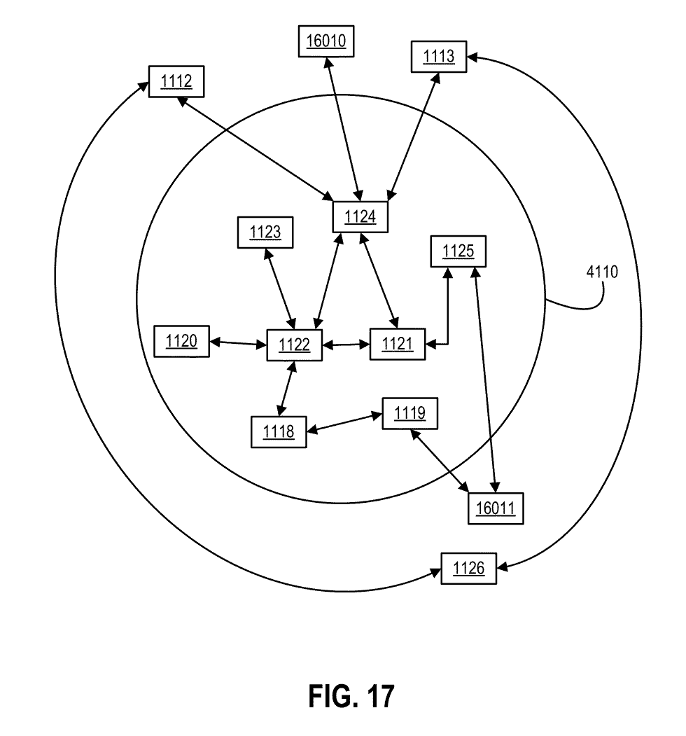

Turning now to FIG. 17, an exemplary diagram of a second determined relation network that includes computing devices is illustrated, according to one or more embodiments. As illustrated, arrows can indicate directions of relation network communications among users and/or accounts of users associated with respective CDs 1112, 1113, 1118, 1119, 1120-1126, 16010, and 16011. For example, communications among users and/or accounts of users associated with respective CDs 1112, 1113, 1118, 1119, 1120-1126, 16010, and 16011 can be utilized in determining a relation network and/or determining locations of computing devices that may not provide one or more locations when communicating.

In one or more embodiments, a determined relation network can include computing devices, users of respective computing devices, and/or accounts of respective users of respective computing devices that communicate bidirectionally with at least one other computing device, at least one other user of at least one other computing device, and/or at least one account of at least one other user of at least one other computing device. For example, CD 1116 can be present in the relation network illustrated in FIG. 16, and CD 1116 can be eliminated and/or ignored in determining the relation network illustrated in FIG. 17 (accordingly, CD 1116 is not illustrated in FIG. 17). For instance, CD 1116 may not communicate bidirectionally with at least one other computing device, at least one other user of at least one other computing device, and/or at least one account of at least one other user of at least one other computing device.

In one or more embodiments, eliminating and/or ignoring a computing device in a relation network can include eliminating and/or ignoring one or more other computing devices that communicate with the computing device that was eliminated. For example, eliminating and/or ignoring CD 1116 can include eliminating and/or ignoring one or more of CDs 1114 and 1115.

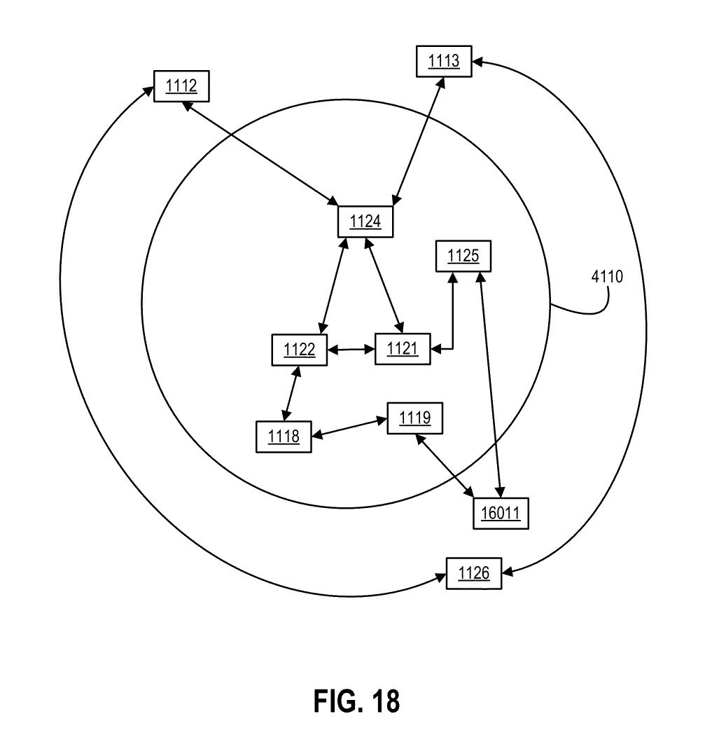

Turning now to FIG. 18, an exemplary diagram of a third determined relation network that includes one or more computing devices is illustrated, according to one or more embodiments. As illustrated, arrows can indicate directions of relation network communications among users and/or accounts of users associated with respective CDs 1112, 1113, 1118, 1119, 1121, 1124, 1125, 1126, and 16011. For example, communications among users and/or accounts of users associated with respective CDs 1112, 1113, 1118, 1119, 1121, 1124, 1125, 1126, and 16011 can be utilized in determining a relation network and/or determining locations of computing devices that may not provide one or more locations when communicating.

In one or more embodiments, a determined relation network can include computing devices, users of respective computing devices, and/or accounts of respective users of respective computing devices that communicate bidirectionally with at least two other computing devices, at least two other users of at least two other computing devices, and/or at least two accounts of at least two other users of at least two other computing devices. For example, CDs 1120 and 16010 can be present in the relation network illustrated in FIG. 17, and CDs 1120 and 16010 can be eliminated and/or ignored in determining the relation network illustrated in FIG. 18.

In one instance, CD 1120 (illustrated in FIG. 17) may not communicate bidirectionally with at least two other computing devices, at least two other users of at least two other computing devices, and/or at least two accounts of at least two other users of at least two other computing devices, and CD 1120 can be eliminated and/or ignored in determining a relation network even though CD 1120 is included in geographic search region 4110. In another instance, CD 16010 (illustrated in FIG. 17) may not communicate bidirectionally with at least two other computing devices, at least two other users of at least two other computing devices, and/or at least two accounts of at least two other users of at least two other computing devices. In one or more embodiments, eliminating and/or ignoring a computing device in a relation network can include eliminating and/or ignoring one or more other computing devices that communicate with the computing device that was eliminated.

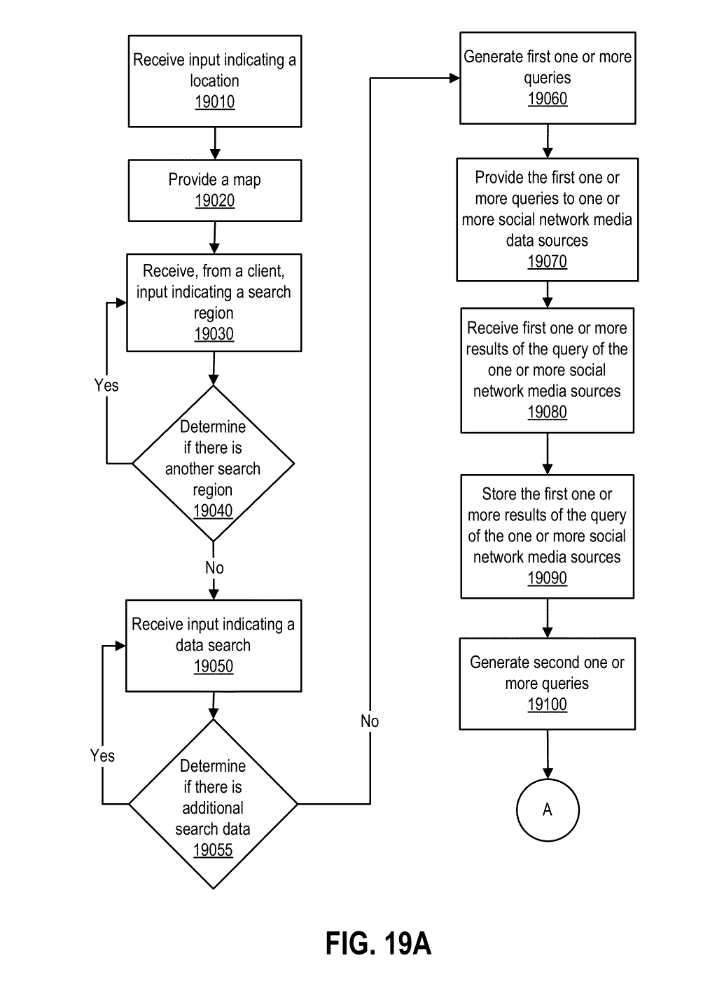

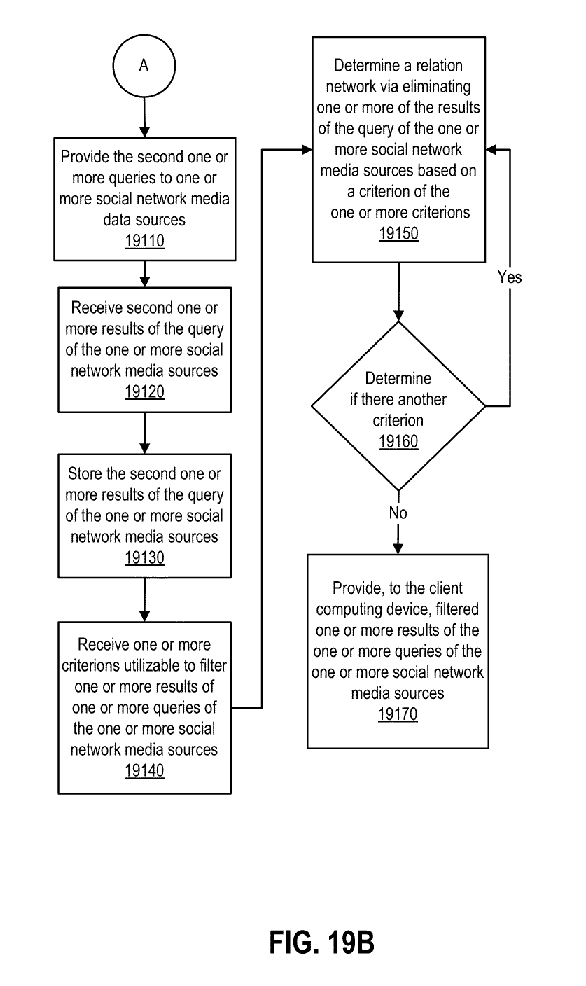

Turning now to FIGS. 19A and 19B, a method of determining a relation network via inclusion of and/or eliminating one or more results is illustrated, according to one or more embodiments. In one or more embodiments, method elements 19010-19090 can be performed in accordance with method elements 3010-3090 of FIG. 3, respectively.

At 19100, second one or more queries can be generated. In one or more embodiments, generating the second one or more queries can include generating the second one or more queries such that at least one of the second one or more queries includes a query for user identifications and/or identifications of user accounts that communicate with one or more users and/or account of one or more users associated with a geographic search region.

In one example, the first one or more results can include one or more users and/or account of one or more users associated with a geographic search region. For instance, at least one of the second one or more queries include can include the query for user identifications and/or identifications of user accounts that communicate with one or more users associated with geographic search region 4110.

In another example, the first one or more results can include communications of one or more users and/or account of one or more users associated with a geographic search region. For instance, the communications of one or more users and/or account of one or more users associated with the geographic search region can include one or more identifications of one or more users, and/or one or more accounts of the one or more users, that communicate with one or more users associated with the geographic region.

At 19110, the second one or more queries can be provided to one or more social media data sources. At 19120, second one or more results of the query of the one or more social media data sources can be received. For example, the second one or more results can include user identifications and/or identifications of user accounts that communicate with one or more users and/or accounts of the one or more users associated with geographic search region 4110. At 19130, the second one or more results can be stored.

In one or more embodiments, determining a relation network associated with a geographic search region can include augmenting first one or more results with second one or more results. For example, user identifications and/or identifications of user accounts determined to be included in geographic search region 4110 can be augmented with user identifications and/or identifications of user accounts determined to communicate with user identifications and/or identifications of user accounts determined to be included in geographic search region 4110. For instance, a relation network associated with geographic search region 4110 can be augmented with user identifications and/or identifications of user accounts that communicate with one or more users associated with geographic search region 4110.

At 19140, one or more criterions, utilizable to filter one or more results of one or more queries of the one or more social media network media sources, can be received. In one example, the one or more criterions can be received via user input. In a second example, the one or more criterions can be received via a processor(s). In one instance, one or more of API servers 2020-2024 can receive the one or more criterions via network 1010. In a second instance, one or more of application servers 2040-2050 can receive the one or more criterions via network 1010. In another instance, receiving the one or more criterions can include receiving the one or more criterions via one or more computer systems and/or one or more artificial intelligence modules.

In a third example, the one or more criterions can be received via a storage device. For instance, receiving the one or more criterions can include receiving the one or more criterions via one or more files that are stored via one or more storage devices. In another example, the one or more criterions can be received via a network. In one instance, the one or more criterions can be received, via a network, from a computer system coupled to the network. In another instance, the one or more criterions can be received, via a network, from storage coupled to the network.

In one or more embodiments, one or more user identifications and/or identifications of user accounts associated with a relation network can be ignored and/or eliminated from the relation network. In one example, one or more user identifications and/or identifications of user accounts associated with a geographic search region can be ignored and/or eliminated from a relation network. In another example, the relation network can be augmented with one or more user identifications and/or identifications of user accounts that communicate with one or more user identifications and/or identifications of user accounts associated with a geographic search region, and one or more user identifications and/or identifications of user accounts that augment the relation network can be ignored and/or eliminated.

In one or more embodiments, determining a relation network can include creating the relation network via determining one or more user identifications and/or identifications of user accounts associated with a geographic search region and ignoring and/or eliminating one or more of the one or more user identifications and/or the identifications of user accounts that do not satisfy the one or more criterions. In one example, a relation network can be initially determined and/or created via one or more user identifications and/or identifications of user accounts associated with a geographic search region that satisfy the one or more criterions.

In another example, a relation network can be initially determined and/or created via one or more user identifications and/or identifications of user accounts associated with a geographic search region that are filtered such that filtering the one or more user identifications and/or identifications of user accounts associated with the geographic search region produces and/or generates the relation network. For instance, filtering the one or more user identifications and/or identifications of user accounts associated with the geographic search region produces and/or generates one or more of the one or more user identifications and/or identifications of user accounts associated with the geographic search region that satisfy the one or more criterions can be utilized as the relation network.

In one or more embodiments, determining a relation network can include creating the relation network via determining one or more user identifications and/or identifications of user accounts that communicate with one or more user identifications and/or identifications of user accounts associated with a geographic search region and ignoring and/or eliminating one or more of the one or more user identifications and/or the identifications of user accounts that communicate with the one or more user identifications and/or identifications of user accounts associated with the geographic search region. For example, one or more user identifications and/or identifications of user accounts that communicate with one or more user identifications and/or identifications of user accounts associated with a geographic search region can augment a relation network, and one or more of the one or more user identifications and/or identifications of user accounts that communicate with the one or more user identifications and/or identifications of user accounts associated with the geographic search region can be ignored and/or eliminated such that all members of the relation network satisfy the one or more criterions.

In another example, a relation network can be initially determined and/or created via one or more user identifications and/or identifications of user accounts, that communicate with one or more user identifications and/or identifications of user accounts associated with a geographic search region, that are filtered such that filtering the one or more user identifications and/or identifications of user accounts, that communicate with the one or more user identifications and/or identifications of user accounts associated with the geographic search region, produces and/or generates the relation network and/or produces and/or generates an augmentation to the relation network. For instance, filtering the one or more user identifications and/or identifications of user accounts, that communicate with the one or more user identifications and/or identifications of user accounts associated with the geographic search region, that satisfy the one or more criterions can be utilized as the relation network or an augmentation to the relation network.

At 19150, one or more of the one or more results of the query of the one or more social media network media sources can be eliminated based on the one or more criterions. In one example, eliminating one or more of the one or more results of the query of the one or more social media network media sources can include eliminating one or more results that are not associated with bidirectional communication. For instance, an eliminated result can correspond to a computing device associated with a user, and/or an account associated with the user where the user and/or the account associated with the user does not have bidirectional communication with at least one other computing device of at least one other user and/or an account associated with the least one other user.

In another example, eliminating one or more of the one or more results of the query of the one or more social media network media sources can include eliminating one or more results that correspond to one or more users and/or one or more accounts of respective one or more users where the one or more users and/or the one or more accounts of the respective one or more users that do not bidirectionally communicate with at least two other users and/or at least two other accounts of respective two other users.

At 19160, it can be determined if there is another criterion. If there is another criterion, the method can proceed to 19150. If there is not another criterion, the method can proceed to 19130. At 19170, filtered one or more results can be provided to a client. In one example, one or more of API servers 2020-2024 can provide the filtered results to the client via network 1010. In another example, one or more of application servers 2040-050 can provide the filtered results to the client via network 1010. In one or more embodiments, the filtered one or more results can be provided to the client in one or more fashions as those described with reference to 3100 of FIG. 3. In one or more embodiments, the filtered one or more results can include a relation network.

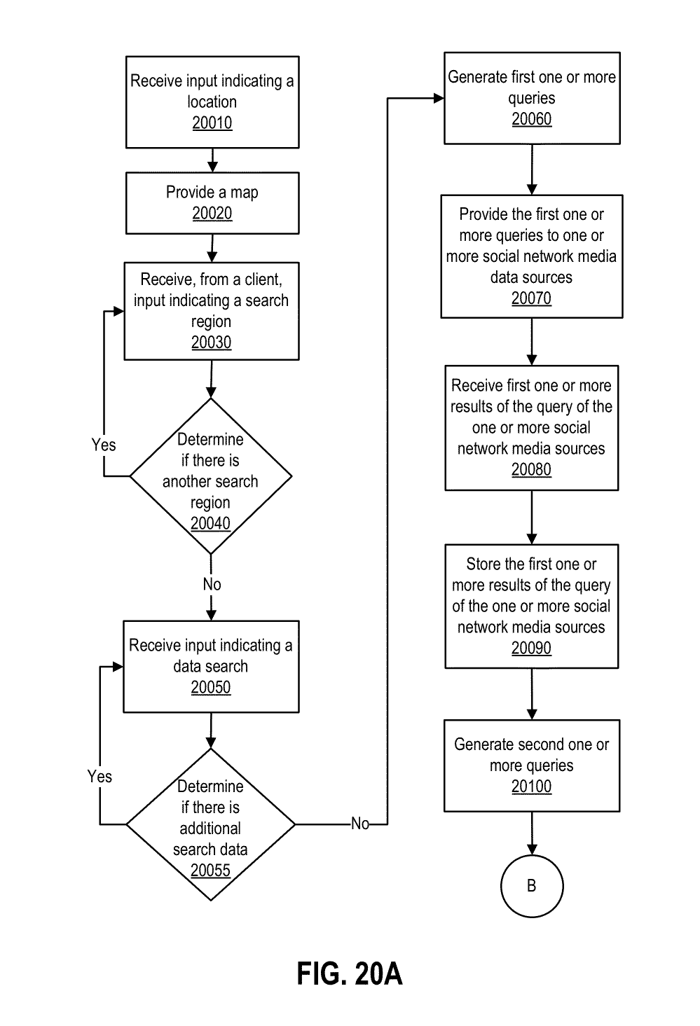

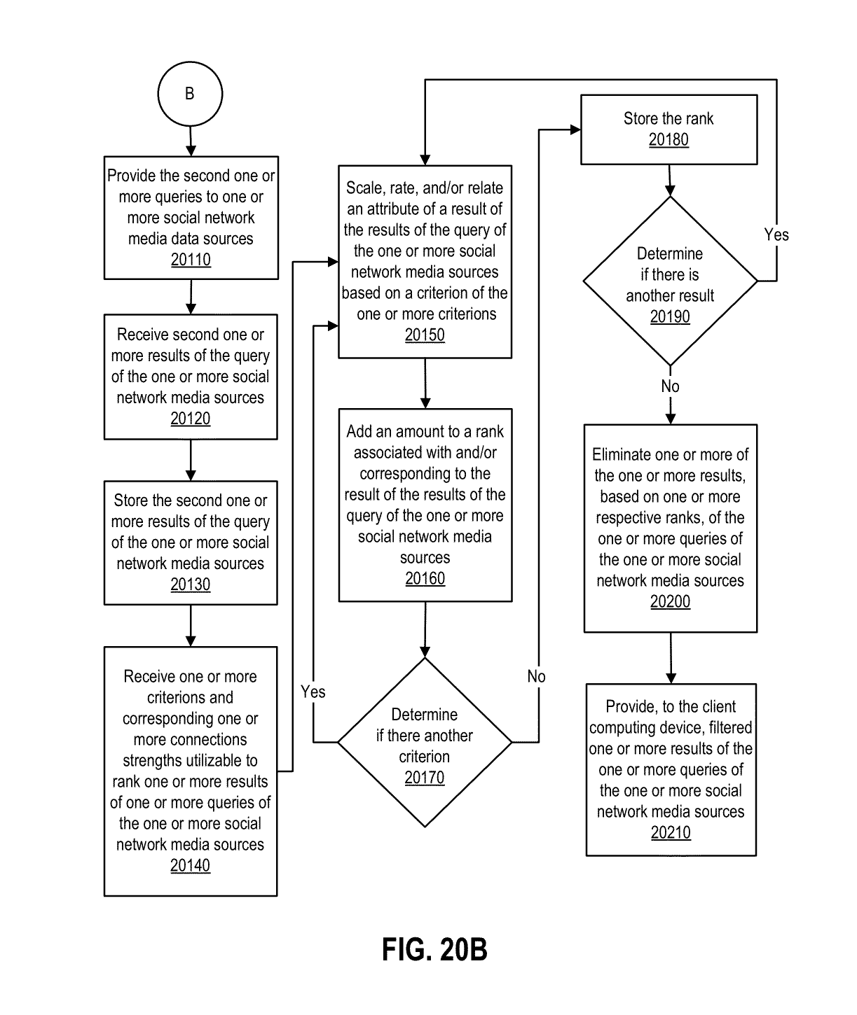

Turning now to FIGS. 20A and 20B, a method of determining a relation network via ranking of one or more results is illustrated, according to one or more embodiments. In one or more embodiments, method elements 20010-20130 can be performed in accordance with method elements 19010-19130, respectively, of FIGS. 19A and 19B.

At 20140, one or more criterions and corresponding one or more connection strengths, utilizable to rank one or more results of one or more queries of the one or more social media network media sources, can be received. In one example, the one or more criterions and corresponding one or more connection strengths can be received via user input. In a second example, the one or more criterions and corresponding one or more connection strengths can be received via a processor(s). In one instance, one or more of API servers 2020-2024 can receive the one or more criterions and corresponding one or more connection strengths via network 1010. In a second instance, one or more of application servers 2040-2050 can receive the one or more criterions and corresponding one or more connection strengths via network 1010. In another instance, receiving the one or more criterions and corresponding one or more connection strengths can include receiving the one or more criterions via one or more computer systems and/or one or more artificial intelligence modules.

In a third example, the one or more criterions and corresponding one or more connection strengths can be received via a storage device. For instance, receiving the one or more criterions and corresponding one or more connection strengths can include receiving the one or more criterions and corresponding one or more connection strengths via one or more files that are stored via one or more storage devices. In another example, the one or more criterions and corresponding one or more connection strengths can be received via a network. In one instance, the one or more criterions and corresponding one or more connection strengths can be received, via a network, from a computer system coupled to the network. In another instance, the one or more criterions and corresponding one or more connection strengths can be received, via a network, from storage coupled to the network.

In one or more embodiments, determining a relation network can include creating the relation network via determining and/or based on how well connected two or more user identifications and/or identifications of user accounts are. For example, one or more criterions and corresponding one or more connection strengths can be utilized in determining how well connected two or more user identifications and/or identifications of user accounts are. For instance, one or more attributes can be associated with a user account, one or more of the one or more criterions can be associated with and/or correspond to the one or more attributes associated with the user account, and one or more of the corresponding one or more connection strengths can be utilized with the one or more attributes in determining how well the user account is connected to one or more other user accounts. In one or more embodiments, a user account can be associated with a profile that can include one or more attributes.

In one or more embodiments, determining a relation network can include creating the relation network via determining and/or based on how well connected a user identification and/or an account associated with the user identification is to a relation network that is based one or more criterions. For example, one or more criterions and corresponding one or more connection strengths can be utilized in determining how well connected a user identification and/or an account associated with the user identification is to a relation network that is based the one or more criterions. For instance, one or more attributes associated with a user identification and/or an account associated with the user identification can be associated with the one or more criterions, and the one or more attributes can be measured (e.g., valued) in accordance with the one or more connection strengths, corresponding to the one or more criterions, to determine how well connected the user identification and/or is account associated with the user identification is to the relation network.

At 20150, a connection strength can be utilized to scale, to rate, and/or to relate a criterion of the one or more criterions to an attribute of one or more attributes of a result. In one example, the connection strength can be utilized as a weight of the attribute associated with and/or corresponding to the criterion. In a second example, the connection strength can be utilized as a rating of the attribute associated with and/or corresponding to the criterion. In another example, the connection strength can be utilized to relate a significance of the attribute associated with and/or corresponding to the criterion.

In one or more embodiments, a connection strength can include and/or be associated with a number (e.g., a positive number, a negative number, or zero). In one example, an attribute of one or more attributes of a result can be multiplied by the number associated with the connection strength that corresponds to a criterion of the one or more criterions. In a second example, a criterion and a corresponding connection strength can be associated with a number of followers of a user and/or an account of the user associated with the result of the one or more results of the query. For instance, the connection strength can be associated with a number of Twitter followers of a user and/or an account of the user associated with the result of the one or more results of the query. In a third example, a criterion and a corresponding connection strength can be associated with a quantity of bidirectional communications of a user and/or an account of the user associated with the result of the one or more results of the query.

In a fourth example, a criterion and a corresponding connection strength can be associated with a quantity message topics in communications of a user and/or an account of the user associated with the result of the one or more results of the query. In one instance, the connection strength can be associated with a number of message topic (e.g., hash-tag) communications of Twitter for a user and/or an account of the user associated with the result of the one or more results of the query. In another instance, the connection strength can be associated with a number of communications (e.g., messages, tweets, etc.) of Twitter for a user and/or an account of the user associated with the result of the one or more results of the query.

In a fifth example, a criterion and a corresponding connection strength can be associated with a registered location of a user and/or an account of the user associated with the result of the one or more results of the query. In one instance, the connection strength can be associated with a distance from the registered location of the user and/or the account of the user to a geographic search region (e.g., geographic search region 4110). In another instance, the connection strength can include a number that could affect (e.g., detract) a resulting rank if a distance from the registered location of the user and/or the account of the user to geographic search region 4110 is not zero.

In a sixth example, a criterion and a corresponding connection strength can be associated with a quantity of “friends” of a user and/or an account of the user associated with the result of the one or more results of the query. For instance, the criterion and the corresponding connection strength can be associated with a quantity of “friends” of a user and/or an account of the user associated with the result of the one or more results of the query that are associated with a geographic search region (e.g., geographic search region 4110).

In a seventh example, a criterion and a corresponding connection strength can be associated with a number of messages, associated with a user and/or an account of the user associated with the result of the one or more results of the query, that include one or more words describing and/or identifying one or more objects within a geographic region. In an eighth example, a criterion and a corresponding connection strength can be associated with a number of images (e.g., pictures, videos, motion pictures, etc.), associated with a user and/or an account of the user associated with the result of the one or more results of the query, that include one or more representations and/or images of one or more objects within a geographic region.

In a ninth example, a criterion and a corresponding connection strength can be associated with a quality of communications associated with a user and/or an account of the user associated with the result of the one or more results of the query. For instance, the quality of communications can be quantified via a number of compliances of communications, associated with the user and/or an account of the user, to a data search (e.g., a data search associated with method element 20050). In another example, a criterion and a corresponding connection strength can be associated with an amount of time since a last communication (e.g., a number of seconds, a number of hours, a number of days, a number of weeks, etc.) of a user and/or an account of the user associated with the result of the one or more results of the query.

In one or more embodiments, a criterion of the one or more criterions may not be associated with a corresponding attribute of a result, and a default attribute may be utilized. For example, one or more of the one or more criterions can be associated with respective one or more default attributes. For instance, a default attribute can include a number that may or may not affect a rank of a result.

In one or more embodiments, one or more of the one or more attributes can be mapped to respective one or more numbers. In one example, a sex attribute (e.g., “male”, “female”, etc.) can be mapped to respective one or more numbers. In a second example, one or more attributes associated with “yes” and “no” values can be mapped to respective one or more numbers (e.g., 1 and 0).

At 20160, an amount, based on a criterion of the one or more criterions and a corresponding connection strength of the one or more connection strengths, can be added to a rank of a result of the one or more results of the query of the one or more social media network media sources. In one or more embodiments, the amount can be a positive number, a negative number, or zero.

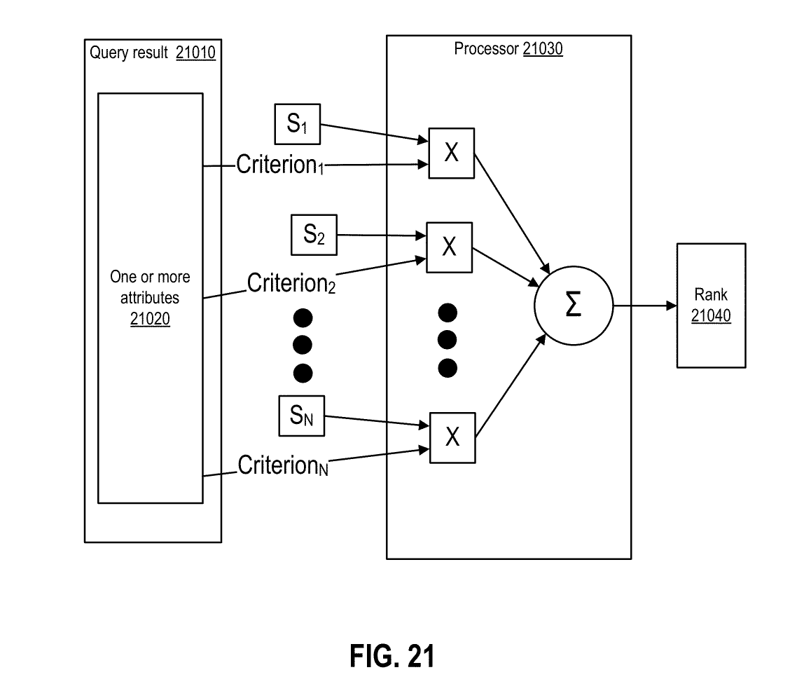

At 20170, it can be determined if there is another criterion to process. If there is another criterion, the method can proceed to 20150. If there is not another criterion, the method can proceed to 20180, where the rank can be stored. In one or more embodiments, method elements 20150-20180 can be represented via a block diagram illustrated in FIG. 21.

At 20190, it can be determined if there is another result of the one or more results of the query of the one or more social media network media sources to process. If there is another result, the method can proceed to 20150. If there is not another result, the method can proceed to 20200, where one or more of the one or more results of the query of the one or more social media network media sources can be eliminated based on one or more respective ranks of the one or more results. In one or more embodiments, one or more of the one or more results of the query of the one or more social media network media sources can be eliminated based on one or more respective ranks of the one or more results where the one or more respective ranks are at an amount, above an amount, at or above an amount, below an amount, or at or below an amount.

At 20210, filtered one or more results of the query of the one or more social media data sources, based on respective ranks, can be provided to a client. In one example, one or more of API servers 2020-2024 can provide the filtered results to the client via network 1010. In another example, one or more of application servers 2040-050 can provide the filtered results to the client via network 1010. In one or more embodiments, the filtered one or more results can be provided to the client in one or more fashions as those described with reference to 3100 of FIG. 3.

Turning now to FIG. 21, a block diagram of a system that determines a rank of a result based on one or more criterions and corresponding one or more connection strengths is illustrated, according to one or more embodiments. As shown, a query result 21010 can include one or more attributes 21020. In one or more embodiments, the one or more attributes can be associated with a user and/or an account of the user associated with query result 21010. For example, the one or more attributes can include one or more attributes of a profile associated with the user and/or an account of the user.

In one or more embodiments, one or more criterions can map and/or relate one or more attributes to one or more corresponding connection strengths. For example, one or more of Criterion₁ . . . Criterion_{N} can map and/or relate one or more attributes 21020 to one or more of corresponding connection strengths S₁ . . . S_{N}.

In one or more embodiments, a processor 21030 can multiply an attribute, or a value associated with the attribute, with a connection strength (e.g., a connection strength of connection strengths S₁ . . . S_{N}). In one or more embodiments, processor 21030 can sum products of connection strengths and respective attributes, or values associated with respective attributes, to produce a rank 21040. For example, processor 21030 can perform multiple multiply and accumulate operations to produce rank 21040. In one or more embodiments, a rank (e.g., rank 21040) can be or include a rating.

Turning now to FIGS. 22A-22C, a method of determining a relation network via elimination of one or more results and via ranking of one or more results is illustrated, according to one or more embodiments. In one or more embodiments, method elements 22010-22150 can be performed in accordance with method elements 19010-19150, respectively, of FIGS. 19A and 19B. At 22160, it can be determined if there is another criterion. If there is another criterion, the method can proceed to 22150. If there is not another criterion, the method can proceed to 23140. In one or more embodiments, method elements 23140-23210 can be performed in accordance with method elements 20140-20210, respectively, of FIGS. 20A and 20B.

In one or more embodiments, a computer system, a computing device, and/or a computer can be broadly characterized to include any device that includes a processor that executes instructions from a memory medium. For example, the term “memory medium” can mean a “memory”, a “memory device”, “storage device”, and/or “tangible computer readable storage medium”. In one instance, one or more of a “memory”, a “memory device”, “storage device” and “tangible computer readable storage medium” can include volatile storage such as random access memory (RAM), SRAM (static RAM), DRAM (dynamic RAM), EDO RAM (extended data out RAM), Rambus RAM, etc. In a second instance, one or more of a “memory”, a “memory device”, and “tangible computer readable storage medium” can include nonvolatile storage such as a ROM (read only memory), a PROM (programmable ROM), an EPROM (erasable PROM), an EEPROM (electrically erasable PROM), flash memory, NVRAM (non-volatile RAM), FRAM (ferroelectric RAM), a CD-ROM, a DVD-ROM, a floppy disk, a magnetic tape, a magnetic media (e.g., a hard drive), optical storage, etc. In another instance, one or more of a “memory”, a “memory device”, and “tangible computer readable storage medium” can include non-transitory computer readable storage. In one or more embodiments, a memory medium can include one or more volatile storages and/or one or more nonvolatile storages.

In one or more embodiments, a processor (e.g., a central processing unit or CPU) can execute instructions from a memory medium that stores the instructions that can include one or more software programs in accordance with one or more of methods, processes and/or flowcharts described herein. In one example, the processor and the memory medium, that stores the instructions which can include one or more software programs in accordance with one or more of methods, processes and/or flowcharts described herein, can form one or more means for one or more functionalities described with references to methods, processes and/or flowcharts herein. In a second example, a GPU and the memory medium, that stores the instructions which can include one or more software programs in accordance with one or more of methods, processes and/or flowcharts described herein, can form one or more means for one or more functionalities described with references to methods, processes and/or flowcharts herein.

In a third example, a FPGA can be configured with one or more configurations in accordance with one or more of methods, processes and/or flowcharts described herein, that can form one or more means for one or more functionalities described with references to methods, processes and/or flowcharts herein. In a fourth example, an ASIC and the memory medium, that stores the instructions which can include one or more software programs in accordance with one or more of methods, processes and/or flowcharts described herein, can form one or more means for one or more functionalities described with references to methods, processes and/or flowcharts herein. In a fifth example, an ASIC can be configured with one or more configurations in accordance with one or more of methods, processes and/or flowcharts described herein, that can form one or more means for one or more functionalities described with references to methods, processes and/or flowcharts herein.

In a sixth example, an ASIC and the memory medium, that stores the instructions which can include one or more software programs in accordance with one or more of methods, processes and/or flowcharts described herein, can form one or more means for one or more functionalities described with references to methods, processes and/or flowcharts herein. In another example, the memory medium, that stores the instructions which can include one or more software programs in accordance with one or more of methods, processes and/or flowcharts described herein, can include, implement, and/or form an article of manufacture. When terms are used in this disclosure in the singular they shall be deemed to include the plural when applicable, and when used herein in the plural to include the singular when applicable.

One or more of the method elements described herein and/or one or more portions of an implementation of a method element can be repeated, can be performed in varying orders, can be performed concurrently with one or more of the other method elements and/or one or more portions of an implementation of a method element, or can be omitted, according to one or more embodiments. In one or more embodiments, concurrently can mean simultaneously. In one or more embodiments, concurrently can mean apparently simultaneously according to some metric. For example, two tasks can be context switched such that such that they appear to be simultaneous to a human. In one instance, a first task of the two tasks can include a first method element and/or a first portion of a first method element. In a second instance, a second task of the two tasks can include a second method element and/or a first portion of a second method element. In another instance, a second task of the two tasks can include the first method element and/or a second portion of the first method element. Further, one or more of the system elements described herein can be omitted and additional system elements can be added as desired, according to one or more embodiments. Moreover, supplementary, additional, and/or duplicated method elements can be instantiated and/or performed as desired, according to one or more embodiments.

One or more modifications and/or alternatives of the embodiments described herein may be apparent to those skilled in the art in view of this description. Hence, descriptions of the embodiments, described herein, are to be taken and/or construed as illustrative and/or exemplary only and are for the purpose of teaching those skilled in the art the general manner of carrying out methods, processes, and/or systems described herein. In one or more embodiments, one or more materials and/or elements can be swapped or substituted for those illustrated and described herein. In one or more embodiments, one or more parts and/or processes can be reversed, and/or certain one or more features of the described one or more embodiments can be utilized independently, as would be apparent to one skilled in the art after having the benefit of this description.

What is claimed is:

1. A system, comprising:
a processor;
a network interface, coupled to the processor and configured to be coupled to a network; and
a memory device coupled to the processor, wherein the memory device stores instructions that are executed by the processor, wherein the system:
receives, from a computing device, a first query of at least one social network media data source including a first input indicating a first geographical search region and a second input indicating search data;
generates at least a second query that includes a request for at least a first identification of a first user account associated with the first geographical search region and that is based on the search data and the at least one social network media data source;
provides, via the network interface and the network, the at least the second query to the at least one social network media data source;
receives, from the at least one social network media data source via the network interface and the network, a first plurality of identifications of the user accounts associated with the first geographical search region;
generates at least a third query that includes a request for at least a second identification of a second user account associated with communications of at least one of the first plurality identifications of user accounts and that is based on the at least one social network media data source;
provides, via the network interface and the network, the at least the third query to the at least one social network media data source;
receives, from the at least one social network media data source via the network interface and the network, a second plurality identifications of user accounts associated with communications of the at least one of the first plurality identifications of user accounts;
determines, based on the first plurality of identifications of user accounts associated with the first geographical search region and the second plurality identifications of user accounts associated with communications of the at least one of the first plurality identifications of user accounts, relations of the at least one of the first plurality of identifications of user accounts and the second plurality identifications of user accounts;
rates the second plurality of identifications of user accounts based on connection strengths of communication attributes of communications associated with the at least one of the first plurality identifications of user accounts that is associated with at least one relation with the second plurality of identifications of user accounts;
eliminates, based on at least one relation criterion and based on at least one rating of ratings of the second plurality identifications of user accounts, at least a first identification of the second plurality identifications of user accounts; and
provides the at least one of at least one of the first plurality identifications of user accounts and at least a second identification of the second plurality identifications of user accounts to the computing device.

2. The system of claim 1, wherein the system further determines a computing device associated with at least one of the second plurality identifications of user accounts is included within the first geographical search region.

3. The system of claim 1, wherein when the system rates the second plurality identifications of user accounts, the system calculates measurements of the connection strengths of the communication attributes of the communications associated with the at least the one of the first plurality identifications of user accounts.

4. The system of claim 3, wherein relation criterions respectively correspond to the connection strengths respectively corresponding to the communication attributes of the communications associated with the at least the one of the first plurality identifications of user accounts.

5. The system of claim 3, wherein when the system calculates measurements of the connection strengths of the communication attributes of the communications, the system provides a measurement as a rating of the ratings of the second plurality identifications of user accounts to a corresponding user account of the first plurality identifications of user accounts.

6. The system of claim 1, wherein the connection strengths of the communication attributes of communications associated with the at least one of the first plurality identifications of user accounts include numerical values.

7. The system of claim 1, wherein the system further:
rates the first plurality identifications of user accounts based on connection strengths of communication attributes of communications associated with the at least one of the first plurality identifications of user accounts; and
eliminates, based on the at least one relation criterion and based on at least one rating of ratings of the first plurality identifications of user accounts, at least a second one of the first plurality identifications of user accounts.

8. The system of claim 1,
wherein the second query includes at least one of a word, a plurality of words, a phrase, a user profile, a portion of a user profile, a regular expression, a natural language filter, a grammar, a social group, an organization, and a user identification;
wherein at least a portion of the user-provided data from the plurality of users corresponds to the at least one result and at least one of the word, the plurality of words, the phrase, the user profile, the portion of the user profile, the regular expression, the natural language filter, the grammar, the social group, the organization, and the user identification; and
wherein the at least one result is based on the at least the portion of the user-provided data from the plurality of users that corresponds to the at least one result and the at least one of the word, the plurality of words, the phrase, the user profile, the portion of the user profile, the regular expression, the natural language filter, the grammar, the social group, the organization, and the user identification.

9. The system of claim 8, wherein the user-provided data includes at least one post to at least one social network service.

10. The system of claim 8, wherein the grammar includes at least one of a set of formation rules for strings in a language, a context-free grammar, a regular grammar, a tree-adjoining grammar, an affix grammar, an attribute grammar, an adaptive grammar, an ambiguous grammar, and a categorical grammar.

11. The system of claim 8, wherein the user-provided data from the plurality of users includes social network user-provided content.

12. The system of claim 1,
wherein the first geographical search region includes a first unsupported geographical search region shape;
wherein the system generates the at least the second query such that a plurality of geographical search region shapes that are supported by the at least one interface of the at least one social network media data source and that include the first unsupported geographical search region shape; and
wherein the system generates the at least the second query such that the plurality of geographical search region shapes, supported by the at least one interface of the at least one social network media data source, include an expansion of the first unsupported geographical search region shape.

13. The system of claim 1,
wherein the system further provides a map to a user; and
wherein the second input includes user input from the user that indicates the first geographical search region on the map.

14. A non-transitory computer readable memory device, comprising instructions that are executable by a processor of a computer system, wherein as the instructions executed by the processor, the computer system:
receives, from a computing device, a first query of at least one social network media data source including a first input indicating a first geographical search region and a second input indicating search data;
generates at least a second query that includes a request for at least a first identification of a first user account associated with the first geographical search region and that is based on the search data and the at least one social network media data source;
provides, via the network interface and the network, the at least the second query to the at least one social network media data source;
receives, from the at least one social network media data source via the network interface and the network, a first plurality of identifications of the user accounts associated with the first geographical search region;
generates at least a third query that includes a request for at least a second identification of a second user account associated with communications of the at least one of the first plurality identifications of user accounts and that is based on the at least one social network media data source;
provides, via the network interface and the network, the at least the third query to the at least one social network media data source;
receives, from the at least one social network media data source via the network interface and the network, a second plurality identifications of user accounts associated with communications of at least one of the first plurality identifications of user accounts;
determines, based on the first plurality of identifications of user accounts associated with the first geographical search region and the second plurality identifications of user accounts associated with communications of the at least one of the first plurality identifications of user accounts, relations of the at least one of the first plurality of identifications of user accounts and the second plurality identifications of user accounts;
rates the second plurality of identifications of user accounts based on connection strengths of communication attributes of communications associated with the at least one of the first plurality identifications of user accounts that is associated with at least one relation with the second plurality of identifications of user accounts;
eliminates, based on at least one relation criterion and based on at least one rating of ratings of the second plurality identifications of user accounts, at least a first identification of the second plurality identifications of user accounts; and
provides the at least one of at least one of the first plurality identifications of user accounts and at least a second identification of the second plurality identifications of user accounts to the computing device.

15. The non-transitory computer readable memory device of claim 14, wherein the computer system further determines a computing device associated with at least one of the second plurality identifications of user accounts is included within the first geographical search region.

16. The non-transitory computer readable memory device of claim 14, wherein when the computer system rates the second plurality identifications of user accounts, the system calculates measurements of the connection strengths of the communication attributes of the communications associated with the at least the one of the first plurality identifications of user accounts.

17. The non-transitory computer readable memory device of claim 16, wherein relation criterions respectively correspond to the connection strengths respectively corresponding to the communication attributes of the communications associated with the at least the one of the first plurality identifications of user accounts.

18. The non-transitory computer readable memory device of claim 16, wherein when the computer system calculates measurements of the connection strengths of the communication attributes of the communications, the system provides a measurement as a rating of the ratings of the second plurality identifications of user accounts to a corresponding user account of the first plurality identifications of user accounts.

19. The non-transitory computer readable memory device of claim 14, wherein the connection strengths of the communication attributes of communications associated with the at least one of the first plurality identifications of user accounts include numerical values.

20. The non-transitory computer readable memory device of claim 14, wherein the computer system further:
rates the first plurality identifications of user accounts based on connection strengths of communication attributes of communications associated with the at least one of the first plurality identifications of user accounts; and
eliminates, based on the at least one relation criterion and based on at least one rating of ratings of the first plurality identifications of user accounts, at least a second one of the first plurality identifications of user accounts.

21. The non-transitory computer readable memory device of claim 14,
wherein the second query includes at least one of a word, a plurality of words, a phrase, a user profile, a portion of a user profile, a regular expression, a natural language filter, a grammar, a social group, an organization, and a user identification;
wherein at least a portion of the user-provided data from the plurality of users corresponds to the at least one result and at least one of the word, the plurality of words, the phrase, the user profile, the portion of the user profile, the regular expression, the natural language filter, the grammar, the social group, the organization, and the user identification; and
wherein the at least one result is based on the at least the portion of the user-provided data from the plurality of users that corresponds to the at least one result and the at least one of the word, the plurality of words, the phrase, the user profile, the portion of the user profile, the regular expression, the natural language filter, the grammar, the social group, the organization, and the user identification.

22. The non-transitory computer readable memory device of claim 21, wherein the user-provided data includes at least one post to at least one social network service.

23. The non-transitory computer readable memory device of claim 21, wherein the grammar includes at least one of a set of formation rules for strings in a language, a context-free grammar, a regular grammar, a tree-adjoining grammar, an affix grammar, an attribute grammar, an adaptive grammar, an ambiguous grammar, and a categorical grammar.

24. The non-transitory computer readable memory device of claim 21, wherein the user-provided data from the plurality of users includes social network user-provided content.

25. The non-transitory computer readable memory device of claim 14,
wherein the first geographical search region includes a first unsupported geographical search region shape;
wherein the computer system generates the at least the second query such that a plurality of geographical search region shapes that are supported by the at least one interface of the at least one social network media data source and that include the first unsupported geographical search region shape; and
wherein the computer system generates the at least the second query such that the plurality of geographical search region shapes, supported by the at least one interface of the at least one social network media data source, include an expansion of the first unsupported geographical search region shape.

26. The non-transitory computer readable memory device of claim 14,
wherein the computer system further provides a map to a user; and
wherein the second input includes user input from the user that indicates the first geographical search region on the map.

27. A method, comprising:
receiving, from a computing device, a first query of at least one social network media data source including a first input indicating a first geographical search region and a second input indicating search data;
generating at least a second query that includes a request for at least a first identification of a first user account associated with the first geographical search region and that is based on the search data and the at least one social network media data source;
providing, via a network interface and a network, the at least the second query to the at least one social network media data source;
receiving, from the at least one social network media data source via the network interface and the network, a first plurality of identifications of the user accounts associated with the first geographical search region;
generating at least a third query that includes a request for at least a second identification of a second user account associated with communications of the at least one of the first plurality identifications of user accounts and that is based on the at least one social network media data source;
providing, via the network interface and the network, the at least the third query to the at least one social network media data source;
receiving, from the at least one social network media data source via the network interface and the network, a second plurality identifications of user accounts associated with communications of at least one of the first plurality identifications of user accounts;
determining, based on the first plurality of identifications of user accounts associated with the first geographical search region and the second plurality identifications of user accounts associated with communications of the at least one of the first plurality identifications of user accounts, relations of the at least one of the first plurality of identifications of user accounts and the second plurality identifications of user accounts;
rating the second plurality of identifications of user accounts based on connection strengths of communication attributes of communications associated with the at least one of the first plurality identifications of user accounts that is associated with at least one relation with the second plurality of identifications of user accounts;
eliminating, based on at least one relation criterion and based on at least one rating of ratings of the second plurality identifications of user accounts, at least a first identification of the second plurality identifications of user accounts; and
providing the at least one of at least one of the first plurality identifications of user accounts and at least a second identification of the second plurality identifications of user accounts to the computing device.

28. The method of claim 27, further comprising:
determining a computing device associated with at least one of the second plurality identifications of user accounts is included within the first geographical search region.

29. The method of claim 27, wherein rating the second plurality identifications of user accounts includes calculating measurements of the connection strengths of the communication attributes of the communications associated with the at least the one of the first plurality identifications of user accounts.

30. The method of claim 29, wherein relation criterions respectively correspond to the connection strengths respectively corresponding to the communication attributes of the communications associated with the at least the one of the first plurality identifications of user accounts.

31. The method of claim 29, wherein calculating measurements of the connection strengths of the communication attributes of the communications providing a measurement as a rating of the ratings of the second plurality identifications of user accounts to a corresponding user account of the first plurality identifications of user accounts.

32. The method of claim 27, wherein the connection strengths of the communication attributes of communications associated with the at least one of the first plurality identifications of user accounts include numerical values.

33. The method of claim 27, further comprising:
rating the first plurality identifications of user accounts based on connection strengths of communication attributes of communications associated with the at least one of the first plurality identifications of user accounts; and
eliminating, based on the at least one relation criterion and based on at least one rating of ratings of the first plurality identifications of user accounts, at least a second one of the first plurality identifications of user accounts.

34. The method of claim 27,
wherein the second query includes at least one of a word, a plurality of words, a phrase, a user profile, a portion of a user profile, a regular expression, a natural language filter, a grammar, a social group, an organization, and a user identification;
wherein at least a portion of the user-provided data from the plurality of users corresponds to the at least one result and at least one of the word, the plurality of words, the phrase, the user profile, the portion of the user profile, the regular expression, the natural language filter, the grammar, the social group, the organization, and the user identification; and
wherein the at least one result is based on the at least the portion of the user-provided data from the plurality of users that corresponds to the at least one result and the at least one of the word, the plurality of words, the phrase, the user profile, the portion of the user profile, the regular expression, the natural language filter, the grammar, the social group, the organization, and the user identification.

35. The method of claim 34, wherein the user-provided data includes at least one post to at least one social network service.

36. The method of claim 34, wherein the grammar includes at least one of a set of formation rules for strings in a language, a context-free grammar, a regular grammar, a tree-adjoining grammar, an affix grammar, an attribute grammar, an adaptive grammar, an ambiguous grammar, and a categorical grammar.

37. The method of claim 34, wherein the user-provided data from the plurality of users includes social network user-provided content.

38. The method of claim 27,
wherein the first geographical search region includes a first unsupported geographical search region shape;
wherein generating the at least the second query includes generating the at least the second query such that a plurality of geographical search region shapes that are supported by the at least one interface of the at least one social network media data source and that include the first unsupported geographical search region shape; and
wherein generating the at least the second query includes generating the at least the second query such that the plurality of geographical search region shapes, supported by the at least one interface of the at least one social network media data source, include an expansion of the first unsupported geographical search region shape.

39. The method of claim 27, further comprising:
providing a map to a user;
wherein the second input includes user input from the user that indicates the first geographical search region on the map.
